(19) United States
(12) Patent Application Publication
(10) Pub. No.: US 2025/0351201 A1
(43) Pub. Date: Nov. 13, 2025

(54) CONFIGURING RESOURCES FOR WIRELESS COMMUNICATIONS AT A NODE

(71) Applicant: Lenovo (Singapore) Pte. Ltd., Singapore (SG)

(72) Inventors: Majid Ghanbarinejad, Lake Forest, CA (US); Vijay Nangia, Woodridge, IL (US)

(73) Assignee: Lenovo (Singapore) Pte. Ltd., Singapore (SG)

(21) Appl. No.: 18/658,945

(22) Filed: May 8, 2024

(51) Int. Cl. H04W 76/10; H04W 72/02; H04W 72/0446; H04W 72/231

(52) U.S. Cl. CPC H04W 76/10; H04W 72/02; H04W 72/0446; H04W 72/231

(57) ABSTRACT

Various aspects of the present disclosure relate to configuring resources for wireless communications at a node. An apparatus, such as a node (e.g., a wireless access and backhaul (WAB) node), uses a first component to establish a wireless connection between a second component of the node and a first base station, the second component of the node including a second base station. The node receives first signaling from the first base station and via the wireless connection that configures resources for communications between the node and one or more devices. The node performs (e.g., transmits or receives) the communications between the node and the one or more devices using at least a portion of the resources. The devices can include the first base station and/or one or more user equipment (UEs).

### TECHNICAL FIELD

The present disclosure relates to wireless communications, and more specifically to resource management.

### BACKGROUND

A wireless communications system may include one or more network communication devices, such as base stations, which may support wireless communications for one or more user communication devices, which may be otherwise known as user equipment (UE), or other suitable terminology. The wireless communications system may support wireless communications with one or more user communication devices by utilizing resources of the wireless communication system (e.g., time resources (e.g., symbols, slots, subframes, frames, or the like)) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may further include a node for wireless communication to establish, via a first component of the node, a wireless connection between a second component of the node and a first base station, the second component of the node including a second base station, receive, from the first base station and via the wireless connection, first signaling configuring resources associated with communications between the node and one or more devices, and perform the communications between the node and the one or more devices based on the resources.

In some implementations of the method and apparatuses described herein, to receive the first signaling, the node transmits, to the first base station and via the wireless connection, second signaling configuring the resources. Additionally, or alternatively, the second signaling includes an indication that the resources include at least one of uplink resources, downlink resources, or flexible resources, and the first signaling includes an indication that one or more resources of the resources are available for the communications, unavailable for the communications, or are to be configured as available or unavailable by third signaling. Additionally, or alternatively, the node selects at least one resource from the resources for performing the communications, where the second signaling includes an indication of the at least one resource, and the second signaling includes an information element (IE) associated with radio resource control (RRC) signaling. Additionally, or alternatively, the first signaling includes an indication that the resources include at least one of uplink resources, downlink resources, or flexible resources. Additionally, or alternatively, the first signaling includes an indication that one or more resources of the resources are available for the communications, unavailable for the communications, or are to be configured as available or unavailable by second signaling.

Additionally, or alternatively, the indication that the one or more resources of the resources are available for the communications is based on one or more of a channel associated with the resources or a signal associated with the resources, and where the node selects at least one resource from the resources for performing the communications based on one or more of the channel associated with the communications or the signal associated with the communications. Additionally, or alternatively, the node transmits, to the first base station and via the wireless connection, third signaling that indicates the one or more resources. Additionally, or alternatively, the first signaling indicates one or more of a periodicity associated with the resources or waveform parameters associated with the communications, the first signaling indicates that the resources are to be used for the communications between the first component of the node and the one or more devices, the first signaling includes RRC signaling, and the one or more devices include at least the second base station. Additionally, or alternatively, the node receives, from the first base station via the wireless connection, second signaling that indicates at least one resource of the resources to use for the communications and that indicates a communication direction associated with the at least one resource, where the communication direction includes at least one of an uplink communication direction or a downlink communication direction, and the second signaling includes a downlink control information (DCI) message or a medium access control-control element (MAC-CE).

Additionally, or alternatively, the node refrains from multiplexing other communications between the second component of the node and the one or more devices with the communications between the first component of the node and the one or more devices on the at least one resource. Additionally, or alternatively, to refrain from multiplexing the other communications between the second component of the node and the one or more devices with the communications between the first component of the node and the one or more devices on the at least one resource, the node determines a capability of the node to multiplex the other communications between the second component of the node and the one or more devices with the communications between the first component of the node and the one or more devices on the at least one resource, and transmits, to the first base station via the wireless connection, third signaling that indicates the capability of the node to multiplex the other communications between the second component of the node and the one or more devices with the communications between the first component of the node and the one or more devices on the at least one resource, where the first signaling is received in response to transmitting the third signaling, and the capability is associated with at least one of time division multiplexing (TDM), frequency division multiplexing (FDM), or full duplex communications.

Additionally, or alternatively, to refrain from multiplexing the other communications between the second component of the node and the one or more devices with the communications between the first component of the node and the one or more devices on the at least one resource, the node receives, from the first base station and via the wireless connection, third signaling that indicates for the node to refrain from multiplexing the other communications between the second component of the node and the one or more devices with the communications between the first component of the node and the one or more devices on the at least one resource. Additionally, or alternatively, the node selects, based on the first signaling configuring the resources, at least one resource from the resources to use for transmitting or receiving the communications, and transmits, to the first base station and via the wireless connection, second signaling that indicates the at least one resource, where the first signaling includes a first IE and the second signaling includes a second IE. Additionally, or alternatively, the node transmits, to the first base station and via the wireless connection, second signaling that indicates at least one of a channel associated with the communications or a signal associated with the communications, and where the communications are between the second component of the node and the one or more devices, and the one or more devices include at least one UE. Additionally, or alternatively, the resources include at least one of a symbol, a slot, a resource block (RB) set, an RB set group.

Some implementations of the method and apparatuses described herein may further include a processor for wireless communication to establish, via a first component of the node, a wireless connection between a second component of the node and a first base station, the second component of the node including a second base station, receive, from the first base station and via the wireless connection, first signaling configuring resources associated with communications between the node and one or more devices, and perform the communications between the node and the one or more devices based on the resources.

Some implementations of the method and apparatuses described herein may further include a method performed by a node, the method including establishing, via a first component of the node, a wireless connection between a second component of the node and a first base station, the second component of the node including a second base station, receiving, from the first base station and via the wireless connection, first signaling configuring resources associated with communications between the node and one or more devices, and performing the communications between the node and the one or more devices based on the resources.

Some implementations of the method and apparatuses described herein may further include a first base station for wireless communication to establish a wireless connection between the first base station and a first component of a node, the node including the first component and a second component including a second base station, and transmit, to the node and via the wireless connection, first signaling configuring resources associated with communications between the node and one or more devices.

### BRIEF DESCRIPTION OF THE DRAWINGS

FIG. 1 illustrates an example of a wireless communications system in accordance with aspects of the present disclosure.

FIGS. 2 and 3 illustrate examples of wireless access and backhaul (WAB) architecture diagrams, in accordance with aspects of the present disclosure.

FIGS. 4 and 5 illustrate examples of protocol stack diagrams, in accordance with aspects of the present disclosure.

FIG. 6 illustrates an example of a WAB architecture diagram, in accordance with aspects of the present disclosure.

FIG. 7 illustrates an example of a signaling diagram, in accordance with aspects of the present disclosure.

FIG. 8 illustrates an example of a WAB node in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a WAB node in accordance with aspects of the present disclosure.

FIG. 12 illustrates a flowchart of a method performed by a NE in accordance with aspects of the present disclosure.

### DETAILED DESCRIPTION

A wireless communications system can include one or more nodes and/or devices that transmit and receive signaling. For example, the wireless communications system can include one or more of a core network (CN), one or more NEs, such as base stations, and/or one or more UEs. In some examples, such as for an integrated access backhaul (IAB) system, a CN and one or more base stations can be connected via a wired connection (e.g., a physical connection, including a fiber optic connection), while the UEs can be connected to the base stations via one or more wireless connections (e.g., an over the air connection via radio frequency signals). However, the wired connections can include physical connections between the network nodes, which are not dynamic and can be expensive to manufacture and install. Thus, the wireless communications system can implement a WAB node that includes a component representative of a base station or other NE, referred to as a WAB-NE component, and a component capable of establishing wireless connections with other base stations or NEs, referred to as a WAB-mobile terminal (MT). The WAB-NE and WAB-MT can share hardware (e.g., radio frequency chains and antennas). However, the WAB-NE and WAB-MT may not coordinate when transmitting and receiving signaling, leading to interference if the WAB-NE and the WAB-MT transmit and receive signaling using overlapping resources, such as time-frequency resources.

As described herein, to reduce or prevent interference between a WAB-NE and a WAB-MT of a WAB node, the WAB-MT can establish a wireless connection with a NE, such as a base station, and can exchange signaling that configures one or more resources for communications between the WAB-NE and the WAB-MT components of the WAB node and other devices. In some variations, the WAB-MT can receive signaling from a NE that indicates resources that are to be used for communications between the WAB node and another device (e.g., the NE or a UE). The WAB-NE and/or WAB-MT can use the indication of the resources and/or a capability of the WAB node to select resources to use for communications between the WAB node and other devices. For example, the WAB node can refrain from multiplexing communications on resources that overlap with the indicated resources. Refraining from multiplexing communications can include not using resources that overlap with the indicated resources or canceling communications that overlap with the indicated resources, such that the WAB-MT and the WAB-NE are not transmitting and receiving in overlapping resources. In some other examples, the WAB node can select resources that reduce or prevent the interference and can perform (e.g., transmit or receive) communications using the selected resources.

Reference is made herein to communicating data or information, such as signaling resources and performing communications between a node and devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

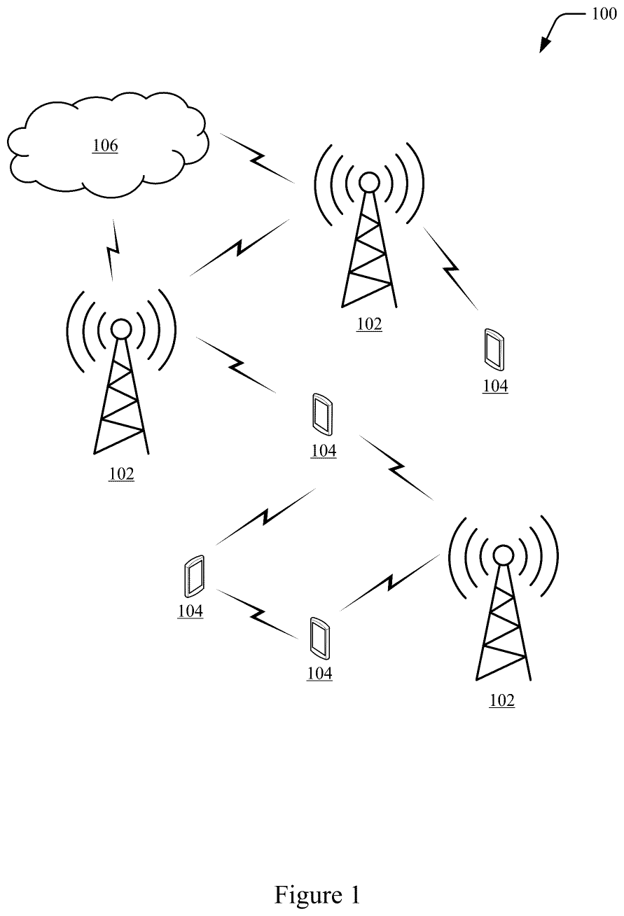

FIG. 1 illustrates an example of a wireless communications system 100 in accordance with aspects of the present disclosure. The wireless communications system 100 may include one or more NE 102, one or more UE 104, and a CN 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or more radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ−0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or more operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or more numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or more numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102, the UEs 104, and a WAB node are operable to implement various aspects of the techniques described with reference to the present disclosure. For example, a NE 102 (e.g., a base station) and a WAB node communicate signaling to coordinate resource usage for communications between the WAB node and the NE 102 and/or between the WAB node and one or more UEs 104. In at least one implementation, the signaling includes RRC signaling, a DCI message, and/or a MAC-CE. The WAB node can perform (e.g., transmit or receive) the communications using at least a portion of resources indicated in signaling between the WAB node and the NE 102.

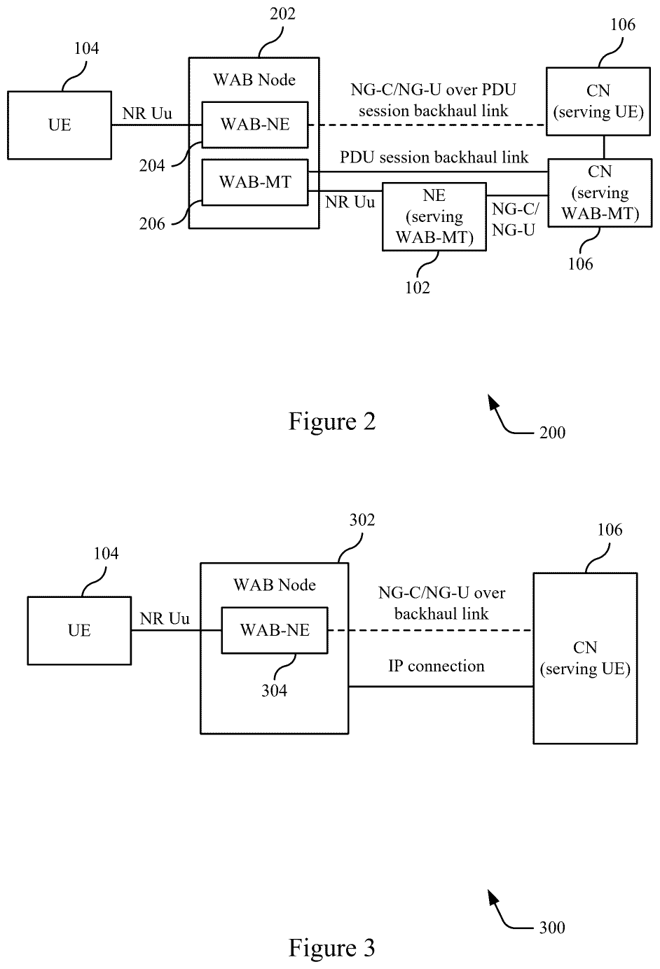

FIG. 2 illustrates an example of a WAB architecture diagram 200 in accordance with aspects of the present disclosure. In some examples, the WAB architecture diagram 200 implements or is implemented by aspects of the wireless communications system 100. For example, the WAB architecture diagram 200 includes a UE 104, a NE 102, and one or more CNs 106, which may be examples of a UE 104, a NE 102, and CNs 106 as described with reference to FIG. 1. The WAB architecture diagram 200 may also include a WAB node 202, where the WAB node 202 may include a component referred to as a WAB-NE 204 and a component referred to as a WAB-MT 206. The WAB-NE 204 may be an example of a NE 102 as described with reference to FIG. 1, such as a base station, a CU of a base station, and/or a DU of a base station. The WAB-MT 206 supports at least a subset of UE functionalities.

In some examples, a wireless communications system can include one or more network nodes for expanding a geographic coverage area and other performance criteria (e.g., signal strength, latency, bandwidth, etc.) for communications in the wireless communications system. The network nodes can include WAB nodes 202, which may also be referred to as femto base stations or femtocells. For example, a WAB node 202 is a relatively small cellular base station (e.g., less than a threshold size) designed for use in residential or business environments. A wireless communications system can include one or more WAB nodes 202 to improve cellular coverage and capacity for environments with a weak signal or insufficient signal quality (e.g., less than a threshold signal strength and/or signal quality) from a base station or a NE 102. A WAB node 202 can include a WAB-NE 204, which can be an example of a full base station (e.g., in contrast with conventional techniques for integrated access and backhaul (IAB) with an IAB node that is not a destination for RRC signaling and therefore does not control resource configurations of a UE).

For example, a wireless communications system can include WAB nodes 202 to expand access to wireless communications for UEs 104 onboard aircrafts, cruise ships, helicopters, and vehicles in remote areas with limited sky visibility via an onboard NE 102 (e.g., gNB). Additionally, or alternatively, a wireless communications system can include WAB nodes 202 to support backhauling of a link between a CN 106 and a NE 102 (e.g., an NG communication link) and a link between NEs 102 (e.g., an Xn communication link) via terrestrial networks and non-terrestrial networks, including support of non-terrestrial networks to terrestrial network handover, and vice-versa, for backhaul. Additionally, or alternatively, a wireless communications system can include WAB nodes 202 to support onboard and/or on-site multi-access edge computing (MEC) and local services. Additionally, or alternatively, a wireless communications system can include WAB nodes 202 to support backhauling without RAN-sharing or roaming agreements between one or more access public land mobile networks (PLMNs) and one or more backhaul PLMNs. Additionally, or alternatively, a wireless communications system can include WAB nodes 202 to support backhauling for a local NE 102 deployed in a public safety or disaster recovery scenarios. In some examples, WAB is aligned with vehicle mounted relay (VMR) use cases. In some variations, single-hop backhauling is sufficient for WAB techniques.

In some cases, the UE 104, the WAB-NE 204, the WAB-MT, the NE 102, and the one or more CNs 106 can communicate via one or more communication links, which can include wired communication links or wireless communication links. A wired communication link can include a physical connection (e.g., fiber optic cable, among other types of physical connections) that provide for devices or nodes in a wireless communications system to transmit and receive data using electrical or optical signals through the cables or wires. A wireless communication link refers to the transmission of data between devices or nodes in a wireless communications system using electromagnetic signals, such as radio waves, infrared, or microwave frequencies, to transmit and receive data over the air. In some examples, a WAB-NE 204 and one or more UEs including a UE 104 can establish a wireless communications link, such as an NR Uu wireless link, to transmit and receive signaling. Additionally, or alternatively, a WAB-MT 206 and a NE 102 that serves the WAB-MT can establish a wireless communications link, such as an NR Uu wireless link. A Uu interface defines a wireless communication link between the UE 104 and the RAN, which includes NEs 102. The Uu interface operates at the radio frequency level and facilitates the transmission of data, control signaling, and other communication between the UE and the RAN over the air. In some cases, the NR Uu wireless link between the WAB-NE 204 and the UEs 104 does not use devices in a non-terrestrial network.

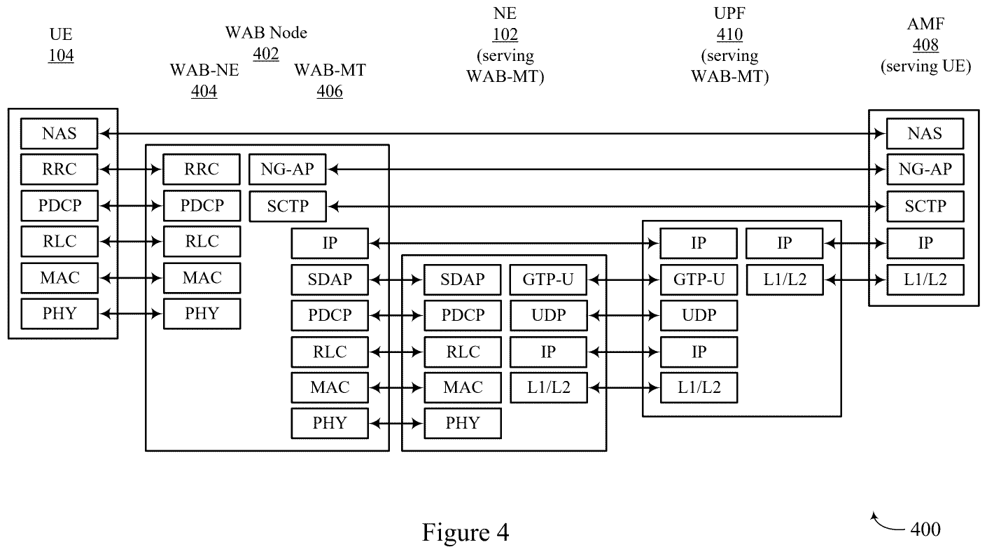

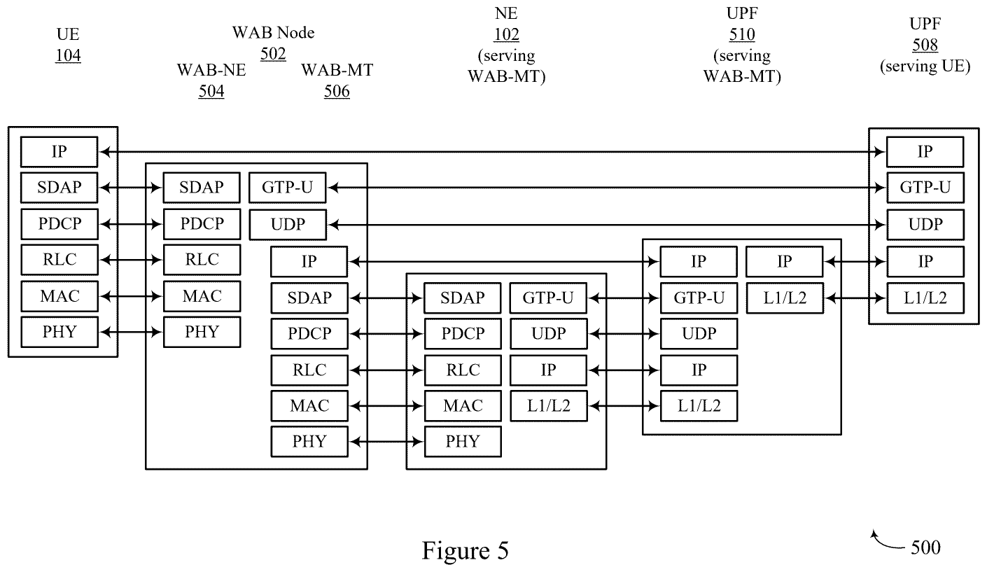

In some cases, a NE 102 that is serving the WAB-MT 206 can establish a wired communication link with a CN 106 that is serving the WAB-MT 206. For example, the NE 102 and the CN 106 that is serving the WAB-MT 206 can establish a next generation-core (NG-C)/next generation-user plane (NG-U) communications link. An NG-C interface represents the interface between a RAN (e.g., NEs 102) and the CN 106. The NG-C interface facilitates the transfer of user data, control signaling, and management information between the NEs 102 or access points and the CN 106 entities, such as a 5GC network functions. An NG-U interface represents the user plane interface within the RAN. The NG-U interface is responsible for the transmission of user data between UEs 104 and the NEs 102 or access points. The control plane and user plane are described in further detail with respect to FIGS. 4 and 5, respectively. The CN 106 serving the WAB-MT 206 and the CN 106 serving the UE 104 can be connected (e.g., via a wired connection) and/or can include one or more of the same entities or components.

In some examples, the WAB-NE 204 can use a PDU session of a WAB-MT 206 via an NR Uu communication link as a backhaul link. For example, the WAB-MT 206 and the CN 106 serving the WAB-MT 206 can establish a PDU session backhaul link. A backhaul link is a network connection that carries user data traffic between different nodes or devices. A PDU session backhaul link refers to a communication link used to transport user data packets between a UPF and other entities in a 5GC network. The UPF is a component within the 5GC network that manages user data packets. For example, the UPF performs data packet routing, forwarding, encapsulation and/or decapsulation, traffic shaping, and policy enforcement for user data traffic. The CN 106 serving the UE 104 and the WAB-NE can use the PDU session backhaul link as an NG-C/NGU communication link (e.g., rather than establishing a wired connection between the WAB-NE 204 and the CN 106 serving the UE 104). In some cases, the WAB-NE 204 serves one or more UEs 104 and does not serve WAB-MTs 206. The WAB-NE 204 and the WAB-MT 206 can connect to a same PLMN or to different PLMNs. Additionally, or alternatively, the WAB-MT 206 can connect to a public PLMN or a standalone non-public network (SNPN), and the WAB-NE 204 can connect to a public PLMN or an SNPN.

One or more devices in a wireless communications systems can support half duplex communication, such that a radio may not transmit and receive signals on same frequencies concurrently. Additionally, or alternatively, one or more devices in a wireless communications system can support full duplex communication, such that a radio may transmit and receive signals on sam3e frequencies concurrently. A WAB-NE 204 and a WAB-MT 206 can share hardware, including radio frequency chains and antennas. A WAB-MT 206 of a WAB node 202 and a WAB-NE 204 of the WAB node 202 may perform communications (e.g., transmit and/or receive signaling) on the same frequencies concurrently, which can lead to self-interference without implementing mechanisms to manage multiplexing the communications.

FIG. 3 illustrates an example of a WAB architecture diagram 300 in accordance with aspects of the present disclosure. In some examples, the WAB architecture diagram 300 implements or is implemented by aspects of the wireless communications system 100 and the WAB architecture diagram 200. For example, the WAB architecture diagram 300 includes a UE 104 and a CN 106, which may be examples of a UE 104 and a CN 106 as described with reference to FIG. 1. The WAB architecture diagram 300 may also include a WAB node 302, where the WAB node 302 may include a component referred to as a WAB-NE 304. The WAB-NE 304 may be an example of a NE 102 as described with reference to FIG. 1, such as a base station, a CU of a base station, and/or a DU of a base station. In some examples, the WAB node 302 may be an example of a WAB node 202, as described with reference to FIG. 2.

In some cases, the UE 104, the WAB-NE 304, and the CN 106 can communicate via one or more communication links, which can include wired communication links or wireless communication links, as described with reference to FIG. 2. In some examples, a WAB-NE 304 and one or more UEs including a UE 104 can establish a wireless communications link, such as an NR Uu wireless link, to transmit and receive signaling. A WAB-NE 304 can establish a wireless communication link with a CN 106 that is serving the UE 104, such as an internet protocol (IP) connection over an internet network or other local network. In some examples, the WAB-NE 304 can use a backhaul link to establish an NG-C/NG-U connection with the CN 106, where the backhaul link may not be a part of a cellular network protocol.

FIG. 4 illustrates an example of a protocol stack diagram 400 in accordance with aspects of the present disclosure. In some examples, the protocol stack diagram 400 implements or is implemented by aspects of the wireless communications system 100, the WAB architecture diagram 200, and the WAB architecture diagram 300. For example, protocol stack diagram 400 is implemented by a UE 104, a WAB node 402 with a WAB-NE 404 and a WAB-MT 406, and a NE 102, which may be examples of the corresponding devices as described with reference to FIGS. 1 through 3. The protocol stack diagram 400 can include an example of a control plane for a UE 104 connected to a network via a WAB node 402.

A control plane is a portion of a network architecture responsible for managing and controlling the establishment, maintenance, and termination of communication sessions and services for a UE 104. In a protocol stack, the control plane includes multiple layers responsible for functions related to controlling and managing network operations. For example, a protocol stack refers to a set of communication protocols that are organized in a layered network architecture to enable networked devices to communicate. A layer in the protocol stack serves functions and interacts with adjacent layers to facilitate the transmission of data between devices over a network. The layers can include a physical (PHY) layer for transmitting and receiving raw data bits over the physical medium, such as radio waves in the air interface. Additionally, or alternatively, the layers can include a medium access control (MAC) layer for managing access to a shared wireless medium. Additionally, or alternatively, the layers can include a radio link control (RLC) layer for providing reliable data transmission over the radio link (e.g., ensuring that packets are delivered correctly and in the correct order). Additionally, or alternatively, the layers can include a packet data convergence protocol (PDCP) layer for handling packet data convergence by adapting higher-layer protocols to the characteristics of the radio interface. Additionally, or alternatively, the layers can include an RRC layer for controlling resources (e.g., time-frequency resources) within the wireless network, including connection establishment, mobility management, and resource allocation. A data link layer (e.g., the second layer (L2)) manages access to a physical medium for a transmission. Additionally, or alternatively, the layers can include one or more other layers, including but not limited to a non-access stratum (NAS) layer, a general packet radio service (GPRS) tunneling protocol-user plane (GTP-U) layer, a user datagram protocol (UDP) layer, a layer 1 (L1) layer, a layer 2 (L2) layer, an IP layer, a stream control transmission protocol (SCTP) layer, a next generation-access protocol (NG-AP) layer, or a service data adaptation protocol (SDAP) layer, among others.

The control plane for a UE 104 can include a NAS layer, RRC layer, PDCP layer, RLC layer, MAC layer, and PHY layer. The RRC, PDCP, RLC, MAC, and PHY layers can have corresponding layers at a control plane of the WAB-NE 404. The NAS layer can have a corresponding layer at a control pane of an access and mobility management function (AMF) 408 that serves the UE 104. An AMF 408 is a network function within a CN (e.g., a 5GC network) for access authentication, authorization, and mobility management for UEs 104. The control plane for the WAB-NE 404 can additionally support NG-AP and SCTP layers, which have corresponding NG-AP and SCTP layers at the AMF 408. The control plane for the WAB-MT 406 can support an IP layer, an SDAP layer, a PDCP layer, an RLC layer, a MAC layer, and a PHY layer. The control plane for the NE 102 that serves the WAB-MT 406 can support corresponding SDAP, PDCP, RLC, MAC, and PHY layers. The IP layer of the WAB-MT 406 can have a corresponding IP layer at a control plane for a UPF 410 that serves the WAB-MT 406. A UPF 410 is a network function within a CN architecture (e.g., a 5GC network) for handling user plane data traffic between a UE 104 and external packet data networks (PDNs), such as the internet or other networks. The control plane for the NE 102 that serves the WAB-MT 406 can also support GTP-U layer, a UDP layer, an IP layer, and a L1/L2, which have corresponding GTP-U, UDP, IP, and L1/L2 layers at the control plane for the UPF 410 that serves the WAB-MT 406. The control plane for the UPF 410 can include an IP layer and L1/L2 that have corresponding IP and L1/L2 layers at the control plane for the AMF 408 that serves the UE 104.

FIG. 5 illustrates an example of a protocol stack diagram 500 in accordance with aspects of the present disclosure. In some examples, the protocol stack diagram 500 implements or is implemented by aspects of the wireless communications system 100, the WAB architecture diagram 200, the WAB architecture diagram 300, and the protocol stack diagram 400. For example, the protocol stack diagram 500 is implemented by a UE 104, a WAB node 502 with a WAB-NE 504 and a WAB-MT 506, and a NE 102, which may be examples of the corresponding devices as described with reference to FIGS. 1 through 4. The protocol stack diagram 500 can include an example of a user plane transport for a UE 104 connected to a network via a WAB node 502.

A user plane is a portion of a network architecture responsible for forwarding and processing user data packets between network devices. In a protocol stack, the user plane includes multiple layers responsible for functions related to forwarding and processing the user data packets. The layers can include an IP layer, a SDAP layer, a PDCP layer, a PHY layer, a MAC layer, an RLC layer, a UDP layer, a GTP-U layer, and/or an L1/L2 layer, among others.

For example, the user plane for a UE 104 can include an IP layer, SDAP layer, PDCP layer, PDCP layer, RLC layer, MAC layer, and PHY layer. The SDAP, PDCP, RLC, MAC, and PHY layers can have corresponding layers at the user plane of a WAB-NE 504. The IP layer can have a corresponding layer at a user plane of a UPF 508 that serves the UE 104. The user plane for the WAB-NE 504 can additionally support GTP-U and UDP layers, which have corresponding GTP-U and UDP layers at the user plane of the UPF 508. The user plane for the WAB-MT 506 can support an IP layer, an SDAP layer, a PDCP layer, an RLC layer, a MAC layer, and a PHY layer. The user plane for the NE 102 that serves the WAB-MT 506 can support corresponding SDAP, PDCP, RLC, MAC, and PHY layers. The IP layer of the WAB-MT 506 can have a corresponding IP layer at a user plane for a UPF 510 that serves the WAB-MT 506. The user plane for the NE 102 that serves the WAB-MT 506 can also support a GTP-U layer, a UDP layer, an IP layer, and a L1/L2, which have corresponding GTP-U, UDP, IP, and L1/L2 layers at the user plane for the UPF 510 that serves the WAB-MT 506. The user plane for the UPF 510 can include an IP layer and L1/L2 that have corresponding IP and L1/L2 layers at the control plane for the UPF 508 that serves the UE 104.

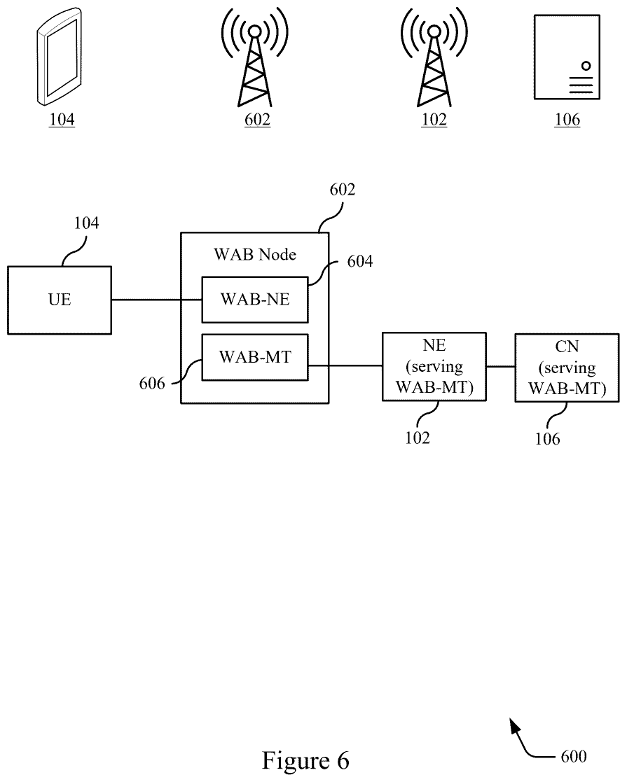

FIG. 6 illustrates an example of a WAB architecture diagram 600 in accordance with aspects of the present disclosure. In some examples, the WAB architecture diagram 600 implements or can be implemented by aspects of the wireless communications system 100, the WAB architecture diagram 200, the WAB architecture diagram 300, the protocol stack diagram 400, and the protocol stack diagram 500. For example, the WAB architecture diagram 600 is implemented by a UE 104, a WAB node 602 with a WAB-NE 604 and a WAB-MT 606, a NE 102, and a CN 106, which may be examples of the corresponding devices as described with reference to FIGS. 1 through 5. The WAB architecture diagram 600 can include an example of a WAB node 602 managing resources for performing communications between a UE 104, the NE 102, and the WAB node 602.

In some examples, one or more CNs 106 (e.g., 5GCs or CN functions, such as an AMF) are connected to a NE 102 via a backhaul link, as described with reference to FIG. 2. The backhaul link can be a wired backhaul link or any other type of backhaul link. A backhaul interface for the backhaul link can be an N2 interface, such as an NG interface, where an N2 interface facilitates communication and coordination between the NE 102 and the CN 106. The NE 102 that serves the WAB-MT 606 may be referred to as a WAB-donor, WAB-anchor, WAB-controller, WAB-manager, or the like. However, the functionality of the WAB-donor may not be similar to that of an IAB-donor, due to differences in the architecture and the protocol stack.

The NE 102 may be connected to a WAB node 602 that includes at least a second base station, referred to as the WAB-NE 604 herein, and a functional entity referred to as a WAB-MT 606. The WAB-MT 606 may share functionalities with a UE 104, although the WAB-MT 606 is a part of the network infrastructure. The purpose of WAB-MT 606 is to connect to the NE 102 with similar processes as those of a UE 104 connecting to a base station. Hence, the link between the WAB-MT 606 and the NE 102 is a wireless access (Uu) link. The Uu link is used to realize a backhaul link between the NE 102 and the WAB-NE 604 (e.g., the traffic of the second backhaul link encapsulated in the Uu link). The backhaul interface is an inter-base-station interface, such as an Xn or X2 interface.

Having connected to the network through the two backhauls, the WAB-NE 604 can serve UEs 104 similar to a conventional base station. The WAB node 602 can include multiple WAB-MTs 606 and/or multiple WAB-NEs 604. The WAB node 602 can be served by multiple NEs 102 (e.g., through one or more WAB-MTs 606). For example, the WAB node 602 can be served by multiple NEs 102 through a dual connectivity (DC) process. The CNs 106 or CN functions connected to the NE 102 and the WAB-NE 604 may be different or may be the same. The NE 102 can serve UEs 104 directly, which is similar to a conventional base station. The WAB-NE 604 can serve multiple UEs 104. The NE 102 can also be an IAB-donor. The WAB node 602 can also be an IAB-node. The network entities, such as the CN 106, the NE 102, and the WAB-NE 604, may be split to according to the 5G RAN architecture or a 6G RAN architecture.

In some examples, the WAB node 602, the UE 104, the NE 102, and the CN 106 can implement a hard/soft/not available (H/S/NA) framework. The WAB-NE 604 is connected to the NE 102 via an Xn interface, which is not a configuring interface (e.g., the Xn interface is not used to configure one NE, here the WAB-NE 604, by anther NE, here NE 102). Instead, the Xn interface is used for peer communications between NEs 102 and is for providing information between the NEs 102 (e.g., rather than for configuring the NEs 102, when compared with an F1 interface). In some cases, the WAB-NE 604 receives a resource configuration from the NE 102 over the Xn interface through the Uu link between the NE 102 and the WAB-MT 606. The resource configuration can include a downlink/uplink/flexible (D/U/F) configuration and/or an H/S/NA configuration for the WAB-NE 604. The WAB-NE 604 then uses the configurations to configure UEs 104 that connect to WAB-NE 604. A D/U/F configuration can include an indication of whether resources are allocated for downlink communication from a NE 102 to a UE 104, uplink communication from a UE 104 to a NE 102, or flexible (e.g., downlink and/or uplink). The D/U/F configuration can include one or more parameters that indicates whether respective resources are downlink, uplink, or flexible. An H/S/NA configuration can include an indication of whether resources are hard, soft, or unavailable.

The WAB-NE 604 may use an H/S/NA configuration to determine whether to use a resource. For example, if a resource is configured as hard (e.g., H), then the WAB-NE 604 may transmit or receive on the resource. Whether the resource is used for transmission or reception by the WAB-NE 604 may depend on whether the resource is configured as downlink or uplink, respectively. If the resource is configured as flexible (e.g., F), then the resource may be used for either transmission or reception by the WAB-NE 604. If a resource is configured as unavailable (e.g., not available (NA)), then the WAB-NE 604 may not transmit or receive on the resource. If a resource is configured as soft (e.g., S), then the WAB-NE 604 may transmit or receive on the resource upon determining that the resource is available. An indication of availability of the resource may be received by a signaling, such as a DCI message, by the WAB-MT 606 from the NE 102.

In various examples, signaling that indicates the availability of a resource may be referred to as an availability indication (AI) or a resource availability indication. An availability indication may indicate whether a resource is available. For example, a resource availability may indicate whether a symbol in a slot or an RB set on a symbol in a slot is available. Additionally, or alternatively, an availability indication may indicate whether a set of resource is available. For example, an availability indication may indicate whether a set of symbols and/or a set of RB sets is available. In some examples, the availability indication may indicate whether all soft downlink resources in a slot, all soft uplink resources in a slot, or all flexible resources in a slot are available.

In some other examples, the WAB-NE 604 sends a first resource configuration to the NE 102, and the NE 102 sends a second resource configuration to the WAB-NE 604. The first resource configuration may include a D/U/F configuration. The second configuration may include an H/S/NA configuration. Additionally, or alternatively, the first resource configuration may include an H/S/NA configuration and the second configuration may include a D/U/F configuration. An availability indication by the NE 102 to the WAB-MT 606 may indicate whether one or more soft resources are available. If an availability indication is associated with soft downlink resources, soft uplink resources, or soft flexible resources, then the WAB node 602 may determine the availability of a resource based on the availability indication, the first configuration, and the second configuration, which may be a combination of signaling and configurations from the NE 102 to the WAB-NE 604 and from the WAB-NE 604 to the NE 102.

If one or more defined or preconfigured channels and/or signals are scheduled for transmission on a resource, then the resource may be considered an H resource by default (e.g., an H/S/NA configuration may not change the attribute to of the resource to S or NA). In some examples, a downlink resource may be a hard resource for a synchronization signal block (SSB) (e.g., a synchronization signal (SS) and/or physical broadcast channel (PBCH) block), a periodic channel state information-reference signal (CSI-RS), a semi-persistent CSI-RS when activated, an aperiodic CSI-RS when triggered, a physical downlink control channel (PDCCH), a PDCCH Type 0, a PDCCH common search space (CSS), a semi-persistent scheduling (SPS)-physical downlink shared channel (PDSCH), and/or a PDSCH when scheduled. Additionally, or alternatively, a downlink resource may be a hard resource for physical random access channel (PRACH), a periodic sounding reference signal (SRS), a semi-persistent SRS when activated, an aperiodic SRS when triggered, a PUCCH, a configured grant (CG)-PUSCH, and/or a PUSCH when scheduled. The NE 102 can obtain information for default H resources (e.g., the defined and/or preconfigured signals or channels that lead to a resource being a hard resource) of the WAB-NE 604. If the NE 102 does not obtain the information, then the NE 102 may fail to predict the behavior of the WAB-NEs 604 on those resources.

In some variations, the WAB-NE 604 receives, from the NE 102, a configuration of channels and/or signals that result in a resource being a hard resource. Then, the WAB-NE 604 may follow the configurations as indicated by the NE 102. Additionally, or alternatively, the WAB-NE 604 receives, from the NE 102, resources on which channels and/or signals that result in a resource being a hard resource. Then, the WAB-NE 604 may configure the channels and/or signals on all or a subset of the indicated resources. In some examples, the WAB-NE 604 may indicate to the NE 102 the subset of the resources on which the channels and/or signals are configured. Additionally, or alternatively, the WAB-NE 604 sends an IE to the NE 102 that includes information of resources on which the WAB-NE 604 configures the channels and/or signals that result in a resource being a hard resource. The IE may include RRC configurations of all or some of the channels and/or signals as OCTET STRING fields.

If the NE 102 is not informed of the WAB-NE 604 configurations, the NE 102 may determine that the WAB-NE 604 does not configure the channels or signals on soft and/or unavailable resources. For example, the NE 102 may determine that the channels and/or signals are configured on resources that are configured as hard resources according to an H/S/NA configuration. Additionally, or alternatively, if the NE 102 is not informed of the WAB-NE 604 configurations, then the NE 102 may assume that the WAB-NE 604 resources may be used for any of the channels and/or signals.

A resource can include a resource in a time domain (e.g., a symbol, a slot, a subframe, a frame, a duration in milliseconds), a resource in a frequency domain (e.g., a physical RB (PRB), an RB group (RBG), an RB set, an RB set group, a sub-band, a bandwidth part (BWP), a component carrier (CC), a frequency band), a frequency-domain resource on a time-domain resource (e.g., an RB set on a symbol), a resource in a spatial domain (e.g., a beam, a reference signal resource indicator, a quasi-colocation (QCL) relationship), and/or a resource in a code domain (e.g., a precoding sequence or matrix).

In some examples, the WAB-MT 606 is configured with a resource configuration by the NE 102. Then, the WAB-NE 604 may determine a behavior for transmitting and/or receiving signals on the resources based on the resource configuration from the NE 102. Thus, the NE 102 configures the resources of the WAB-MT 606 instead of, or in addition to, resources of the WAB-NE 604. In some cases, the WAB-MT 606 is configured with multiple resources, for example by the RRC layer of the NE 102. The configuration may indicate to the WAB-MT 606 that the resources may or may not be used for the Uu link between the NE 102 and the WAB-MT 606. The resources may be periodic with a periodicity that is indicated by the configuration as a number of slots, N. Since the duration of a slot can depend on one or more waveform parameters, such as an OFDM subcarrier spacing (SCS), the waveform parameters may be indicated by the configuration, or otherwise determined by another configuration or scheme.

The configured resources are repeated every N slots. Then, whether the WAB-MT 606 uses a resource for communications (e.g., downlink reception or uplink transmission) may be determined by the WAB-MT 606 based on an additional indication from the NE 102. The additional indication can be included in L1/L2 signaling or in RRC signaling. An example of LI signaling is a DCI (e.g., a DCI format 2-X). In some other examples, a DCI message (e.g., a DCI format 2-5) may be reused or enhanced for indicating the usage of a resource for a reception and/or transmission by the WAB-MT 606. In yet other examples, a MAC-CE message with a logical channel identifier (LCID), X, may be used for the indication. In some cases, the resources may be referred to as allocated resources or provisional resources, and the DCI 2-X or the MAC-CE with LCID=X may indicate whether one or more of the allocated resources are to be used in one or more of the N-slot periods. The DCI message (e.g., the DCI 2-X and/or DCI 2-5), the MAC-CE with LCID=X, or other such message may be referred to as a resource usage indication.

Upon receiving the resource usage indication, the WAB-MT 606 decodes the message and determines the resources that are to be used for a later reception and/or transmission with the NE 102. This information may then be used by the WAB node 602 to determine whether to multiplex other communications by the WAB-NE 604. In some examples, if the WAB node 602 is not capable of multiplexing other communications with a reception and/or transmission by the WAB-MT 606 on the allocated resources (e.g., the resources that are indicated to be used), then the WAB node 602 may determine not to schedule or configure the other communications on resources that are multiplexed with the allocated resources that are indicated by the NE 102 to be used for the reception and/or transmission by the WAB-MT 606.

In some examples, the WAB node 602 may not be capable of multiplexing a first uplink transmission by the WAB-MT 606 (e.g., to the NE 102) and a second uplink reception by the WAB-NE 604 (e.g., from a UE 104). For example, the WAB-MT 606 and the WAB-NE 604 can be collocated and/or share antenna and/or radio frequency hardware. Then, if the WAB-MT 606 receives a resource usage indication that indicates that one or more allocated resources are to be used for the first uplink transmission by the WAB-MT 606, then the WAB-NE 604 does not schedule or configure the second uplink reception on resources that are multiplexed with the one or more allocated resources. In some other examples, the WAB node 602 may not be capable of multiplexing a first DL Rx by the WAB-MT 606 (e.g., from the NE 102) and a second downlink transmission by the WAB-NE 604 (e.g., to a UE 104). For example, the WAB-MT 606 and the WAB-NE 604 can be collocated and/or share antenna and/or radio frequency hardware. Then, if the WAB-MT 606 receives a resource usage indication that indicates that one or more allocated resources are to be used for the first downlink reception by the WAB-MT 606, then the WAB-NE 604 does not schedule or configure the second downlink transmission on resources that are multiplexed with the one or more allocated resources.

In some other examples, the WAB node 602 may not be capable of multiplexing a first uplink transmission by the WAB-MT 606 (e.g., to the NE 102) and a second downlink transmission by the WAB-NE 604 (e.g., to a UE 104). For example, the WAB-MT 606 and the WAB-NE 604 can be collocated and/or share antenna and/or radio frequency hardware. Then, if the WAB-MT 606 receives a resource usage indication that indicates that one or more allocated resources are to be used for the first uplink transmission by the WAB-MT 606, then the WAB-NE 604 does not schedule or configure the second downlink transmission on resources that are multiplexed with the one or more allocated resources. In yet some other examples, the WAB node 602 may not be capable of multiplexing a first downlink reception by the WAB-MT 606 (e.g., from the NE 102) and a second uplink reception by the WAB-NE 604 (e.g., from a UE 104). For example, the WAB-MT 606 and the WAB-NE 604 can be collocated and/or share antenna and/or radio frequency hardware. Then, if the WAB-MT 606 receives a resource usage indication that indicates that one or more allocated resources are to be used for the first downlink reception by the WAB-MT 606, then the WAB-NE 604 does not schedule or configure the second uplink reception on resources that are multiplexed with the one or more allocated resources.

In some cases, the allocated resources are configured for a WAB-MT 606, which is different from an IAB system in which resources are configured for an IAB-DU. That is, in an IAB system, several conditions are specified for the IAB-node to determine whether a resource is available to the IAB-DU based on an availability indication or other factors. In comparison, an allocated resource configuration and a resource usage indication does not specify a list of conditions. Instead, whether the WAB-NE 604 can schedule or configure a communication on resources that are multiplexed with the allocated resources can be determined based on signaling and/or a capability of the WAB node 602, among other factors.

Conventionally, for an H/S/NA framework, a resource that is configured as His available to the IAB-DU and a resource configured as NA is unavailable to the IAB-DU by configuration. Thus, the behavior of the IAB-node with respect to using H and NA resources for the IAB-DU is indicated by the configuration. However, the behavior of the IAB-node for S resources cannot be fully configured. In the case that the IAB-node is capable of full duplex or otherwise multiplexing the resources, the availability indication may not determine the behavior of the IAB-node, leading to inconsistencies in the H/S/NA framework. In some examples (e.g., in contrast to conventional techniques), the WAB node 602 can determine whether to schedule or configure a transmission and/or reception on resources multiplexed with the allocated resources.

In some examples, the NE 102 can configure the WAB-MT 606 with allocated resources. Additionally, or alternatively, the NE 102 may indicate to the WAB-NE 604, via an Xn signaling over the Uu link, resources that are H or NA. Then, the behavior of the WAB-NE 604 on the H and/or NA resources may be determined based on the Xn signaling indication, while the WAB node 602 can determine whether the WAB-NE 604 performs communications using resources multiplexed with the allocated resources. In some examples, whether the WAB-NE 604 follows the Xn signaling for H or NA resources may be indicated by the WAB-NE 604 back to the NE 102. For example, the NE 102 may send a first Xn application protocol (AP) IE including a first indication of a set of resources that the NE 102 requests from WAB-NE 604 to use unconditionally (e.g., H) or not to use unconditionally (e.g., NA). Then, in response, the WAB-NE 604 may send a second XnAP IE including a second indication of whether the WAB-NE 604 accepts, fully or partially, the request from the NE 102. If the request is partially accepted, then the second XnAP IE may include an indication of the subset of the resources that the WAB-NE 604 accepts as H and/or NA. In some examples, the first XnAP IE may be referred to as a Resource Config Request and the second XnAP IE may be referred to as a Resource Config Response. If the request is fully accepted, then the second XnAP IE may be referred to as a Resource Config Success or a Resource Config acknowledge (ACK). If the request is fully rejected, the second XnAP IE may be called a Resource Config Failure, or a Resource Config negative acknowledge (NACK).

In some cases, a resource usage indication may indicate for the WAB-NE 604 to refrain from scheduling or configuring (e.g., to not schedule or configure or cancel) a transmission and/or reception with a UE 104 on resources that are multiplexed with one or more of the allocated resources. The resource usage indication can be L1 signaling (e.g., a DCI message) or L2 signaling (e.g., a MAC-CE message), and can therefore be adopted at smaller timescales (e.g., milliseconds) compared to modifying an H/NA configuration by RRC signaling, which can take tens or hundreds of milliseconds. The NE 102 can configure the WAB node 602 behavior by the NE 102 for interference management, resource management, or the like.

In some variations, at least two sets of allocated resources can be configured, a first set of resources for a behavior determined by implementation and a second set of resources for a behavior enforced by the NE 102. In some other variations, allocated resources may be used for a behavior based on implementation, while the H/S/NA framework may be used for a behavior enforced by the NE 102, or vice versa.

Downlink and uplink refers to a communication direction between a UE or a UE-link (e.g., MT) entity to a serving base station (e.g., NE 102). For a Uu link between the NE 102 and the WAB-MT 606, downlink refers to the link from the NE 102 to the WAB-MT 606, and conversely, uplink refers to the link from the WAB-MT 606 to the NE 102. For a Uu link between the WAB-NE 604 and the UE 104, downlink refers to the link from the WAB-NE 604 to the UE 104, and conversely, uplink refers to the link from the UE 104 to the WAB-NE 604.

Example downlink signals and channels that the NE 102 may schedule and/or configure for the WAB-MT 606 or the WAB-NE 604 may schedule and/or configure for the UE 104 include, but are not limited to SSBs, CSI-RSs, control resource sets (CORESETs), a PDCCH, a PDSCH, and/or an SPS-PDSCH, among others. Example uplink signals and channels that the NE 102 may schedule and/or configure for the WAB-MT 606 or the WAB-NE 604 may schedule and/or configure for the UE 104 include, but are not limited to a PRACH, an SRS, a PUCCH, a PUSCH, and/or a CG-PUSCH, among others. In various examples, behavior for some signals and/or channels may be different compared to behavior for other signals/channels. The difference may depend on factors, such as a priority of the signals and/or channels. For example, a high-priority signal, such as an SSB, CSI-RS, PDCCH, PRACH, or scheduling request (SR) may be assigned a hard resource.

In some examples, the first Uu link between the NE 102 and the WAB-MT 606 may be referred to as an upstream Uu link or upstream link. The second Uu link between the WAB-NE 604 and the UE 104 may be referred to as the downstream Uu link or downstream link. In some examples, resource multiplexing refers to multiplexing among resources used for first communications (e.g., downlink and/or uplink) on the upstream link and second communications (e.g., downlink and/or uplink) on the downstream link. Multiplexing among resources on the two links is a subject of discussion for the WAB system because different WAB nodes 602 may have different capabilities for performing communications on the two links concurrently. In some cases, the WAB node 602 may be capable of half duplex, but not full duplex. For example, if the WAB-MT 606 transmits a signal on the upstream link (e.g., to the NE 102), then the WAB-NE 604 may not receive a signal on the downstream link (e.g., from the UE 104) concurrently. Additionally, or alternatively, if the WAB-MT 606 receives a signal on the upstream link (e.g., from the NE 102), then the WAB-NE 604 may not transmit a signal on the downstream link (e.g., to the UE 104) concurrently. The WAB node 602 may be capable of half duplex communications (e.g., and not full duplex communications) if the WAB-MT 606 and the WAB-NE 604 are collocated and/or share antenna and/or radio frequency hardware.

If the WAB node 602 is capable of half duplex, but not full duplex, then the WAB node 602 can perform transmission or reception by the WAB-MT 606 and the WAB-NE 604 using TDM techniques, possibly with a guard-time between transmission and reception that may depend on implementation of the radio frequency hardware. For TDM techniques, multiple signals are transmitted at different time intervals. For example, the signals can be interleaved in time in respective time intervals, which provides for multiple signals to share a same transmission medium without interfering with one another. When TDM is applied, the WAB node 602 may further use FDM techniques for transmissions by the WAB-MT 606 and the WAB-NE 604 or FDM techniques for receptions by the WAB-MT 606 and the WAB-NE 604. For FDM techniques, multiple signals are transmitted using different frequency bands within a bandwidth. For example, the signals can be interleaved in frequency in respective frequency bands, which provides for multiple signals to share a same transmission medium without interfering with one another. If FDM is used, then simultaneous transmissions by the two entities on the two links may be multiplexed on non-overlapping frequency resources (e.g., non-overlapping PRBs), possibly with a guard-band in between, and similarly simultaneous receptions by the two entities on the two links may be multiplexed on non-overlapping frequency resources (e.g., non-overlapping PRBs), possibly with a guard-band in between.

In some examples, the WAB node 602 may be capable of full duplex communications (e.g., the WAB-MT 606 and the WAB-NE 604 may respectively transmit and receive signals simultaneously, or vice versa). A full duplex radio may be implemented by proper isolation of transmission and reception antenna and/or radio frequency hardware, as well as signaling processing for canceling self-interference. If the WAB node 602 is capable of full duplex communications, then the WAB node 602 may not use TDM techniques. However, the WAB node 602 may use FDM of transmission by the WAB-MT 606 and reception by the WAB-NE 604, and vice versa. If FDM is used, then simultaneous transmission and reception by the two entities on the two links may be multiplexed on non-overlapping frequency resources (e.g., non-overlapping PRBs), possibly with a guard-band in between.

Additionally, or alternatively, multiplexing may refer to the spatial domain with reference to the beams that the two entities of the WAB node 602 may use for the transmission and/or reception on the two links. In some cases, when a the WAB-MT 606 uses a first beam for a first transmission or reception on the upstream link, the WAB-NE 604 may not use a second beam for a second transmission or reception on the downstream link due to one or more interference values exceeding respective threshold values. The one or more interference values can include a self-interference value, such as for an interference between the WAB-MT 606 and the WAB-NE 604. Additionally, or alternatively, the one or more interference values can include cross-link interference (CLI) from downstream to upstream (e.g., an interference by the WAB-NE 604 to the NE 102 or from the UE 104 to the WAB-MT 606) or from upstream to downstream (e.g., an interference by the NE 102 to the WAB-NE 604 or from the WAB-MT 606 to UE 104). Additionally, or alternatively, the one or more interference values can include inter-cell interference (ICI), such as an interference between the NE 102 and the UE 104. An interference between two beams may be detected by interference measurement and reporting. Then, a signaling such as a MAC-CE message from the NE 102 to WAB-MT 606 may indicate a first one or more beams that are recommended or restricted for the downstream link if a second one or more beams are used on the upstream link.

Signaling and behavior in various examples described herein may depend on the capability of the WAB node 602 to multiplex transmission and/or reception between the two links. In some cases, the NE 102 may use information of the multiplexing capability of the WAB node 602 to configure the WAB-MT 606, transmit usage indication or availability indication, send XnAP IEs to the WAB-NE 604, or the like. Additionally, or alternatively, the NE 102 may use the information for determining whether and what resources to indicate for usage and/or availability or what behavior to expect from the WAB node 602. A multiplexing capability of the WAB node 602 may include a capability of the WAB node 602 to implement TDM techniques, a capability of the WAB node 602 to implement half duplex communications, a capability of the WAB node 602 to implement full duplex communications, a capability of the WAB node 602 to implement transmission by the WAB-MT 606 and transmission by the WAB-NE 604, a capability of the WAB node 602 to implement reception by the WAB-MT 606 and reception by the WAB-NE 604, a capability of the WAB node 602 to implement reception by the WAB-MT 606 and transmission by the WAB-NE 604, a capability of the WAB node 602 to implement transmission by the WAB-MT 606 and reception by the WAB-NE 604, and/or a capability of the WAB node 602 to implement FDM techniques, among others.

In some cases, the capability may be signaled via an RRC IE from the WAB-MT 606 to the NE 102. Additionally, or alternatively, the capability may be signaled via an XnAP IE from the WAB-NE 604 to the NE 102. In some examples, if the WAB node 602 indicates that the WAB node 602 is capable of TDM techniques (e.g., and no other multiplexing techniques), half duplex (e.g., and no other multiplexing techniques), or FDM techniques (e.g., and no other multiplexing techniques), then the NE 102 may configure the WAB-MT 606 with allocated resources via RRC and/or indicate H and/or S and/or NA resources to the WAB-NE 604 via Xn. In some examples, if the WAB node 602 indicates that the WAB node 602 is capable of performing full duplex communication, transmission by the WAB-MT 606 and transmission by the WAB-NE 604, a capability of the WAB node 602 to implement reception by the WAB-MT 606 and reception by the WAB-NE 604, a capability of the WAB node 602 to implement reception by the WAB-MT 606 and transmission by the WAB-NE 604, a capability of the WAB node 602 to implement transmission by the WAB-MT 606 and reception by the WAB-NE 604, or if FDM techniques are not implemented, then the NE 102 may not configure (e.g., refrain from configuring) the WAB-MT 606 with allocated resources via RRC or indicate H and/or S and/or NA resources to the WAB-NE 604 via Xn. Additionally, or alternatively, whether the NE 102 configures resources, indicates usage and/or availability, or indicates spatial and/or beam constraints (e.g., such as recommended or restricted beams) may further depend on detecting interference, such as CLI or ICI. The multiplexing capability of the WAB node 602 or other entities in the WAB system may be determined based on self-interference.

In some cases, L1 and/or L2 signaling for indicating usage of allocated resources, for example DCI 2-X or MAC-CE with an LCID=X, may indicate one or more resources that are to be used or not to be used. Additionally, or alternatively, the resource usage indication may indicate whether one or more resources are to be used for downlink or uplink. Depending on the implementation, this additional information may be used by the WAB node 602 to determine whether to schedule or configure a communication on multiplexed resources. In some examples, an L1 and/or L2 message may include a field that indicates that downlink resources or allocated downlink resources in a slot are to be used. In some other examples, the L1 and/or L2 message may include a field that indicates that uplink resources or allocated uplink resources in a slot are to be used. In yet other examples, the L1 and/or L2 message may include a field that indicates that F resources in a slot are to be used for downlink. In yet other examples, the L1 and/or L2 message may include a field that indicates that F resources or allocated F resources in a slot are to be used for uplink. A resource may refer to a radio resource in the time domain (e.g., a symbol), a radio resource in the frequency domain (e.g., an RB set), or any combination thereof.

Various examples specify behavior, such as scheduling or configuring a transmission and/or reception on the downstream link, based on a configuration and indication by the NE 102. With respect to other resources that are not configured as provisional or H and/or S and/or NA by the NE 102, the WAB node 602 may have different behaviors. In some examples, if a resource is not configured and/or indicated used, then the WAB-NE 604 may determine that the resource is available. In some other examples, if a resource is not configured and/or indicated used, then the WAB-NE 604 may not determine that the resource is available. In yet other examples, if a resource is not configured and/or indicated used, then the WAB-NE 604 may follow a behavior indicated by an RRC configuration from the NE 102, an XnAP indication from the NE 102, or a configuration by an operations, administration, and maintenance (e.g., OAM) interface.

In some examples, one or more signals and channels may lead to a resource being a hard resource (e.g., always available). If a signal and/or channel is periodic, then the resources used for the signal and/or channel in the periods may be considered H (e.g., always available). This may indicate to the NE 102 not to use multiplexed and/or simultaneous resources for an upstream transmission and/or reception. However, if the signal and/or channel is not periodic, for example, if the signal and/or channel is semi-persistent or aperiodic or the transmission is conditional, then determining that the resources are used on the downstream link may lead to underutilization of multiplexed resources.

In some cases, whether a signal and/or channel is used on the downstream link may be signaled by the WAB node 602 to the NE 102. The signaling may be an L1 signaling (e.g., an uplink control information (UCI) message) or an L2 signaling (e.g., a MAC-CE message). The WAB node 602 may indicate to the NE 102 whether a semi-persistent signal and/or channel, for example, is a semi-persistent CSI-RS, is activated. If the signal and/or channel is activated, then the NE 102 may assume that the resource is used in the downstream link. In response, the NE 102 may not use (e.g., refrain from using) multiplexed and/or simultaneous resources for scheduling and/or configuring an upstream transmission and/or reception. Otherwise, if the signal and/or channel is not activated, then the NE 102 may assume that the resource is not used in the downstream link. In response, the NE 102 may use multiplexed and/or simultaneous resources for scheduling and/or configuring an upstream transmission and/or reception.

In some cases, the WAB node 602 may indicate to the NE 102 whether an aperiodic signal and/or channel, for example an aperiodic CSI-RS, is triggered in a slot or symbol. If the signal and/or channel is triggered, then the NE 102 may determine that the resource is used in the downstream link in the slot or symbol. In response, the NE 102 may not use multiplexed and/or simultaneous resources in the slot or symbol for scheduling and/or configuring an upstream transmission and/or reception. Otherwise, if the signal and/or channel is not triggered, then the NE 102 may assume that the resource is not used in the downstream link in the slot or symbol. In response, the NE 102 may use multiplexed and/or simultaneous resources for scheduling and/or configuring an upstream transmission and/or reception in the said slot or symbol.

In some variations, the WAB node 602 can determine whether one or more conditions for transmitting an SR are met by a UE 104 and can indicate the results of the determination to the NE 102. The conditions can include, but are not limited to, an SR counter being less than a threshold value (e.g., not exceeding a maximum number of SR transmissions), a prohibit timer for the SR is not running, an occasion of the SR resource being located within a measurement gap, and/or any other condition. If the conditions for transmitting an SR are met by the UE 104, then the NE 102 may determine that the resource is used in the downstream link. In response, the NE 102 may not use multiplexed and/or simultaneous resources for scheduling and/or configuring an upstream transmission and/or reception. Otherwise, if the conditions for transmitting an SR are not met by the UE 104, then the NE 102 may assume that the resource is not used in the downstream link. In response, the NE 102 may use multiplexed and/or simultaneous resources for scheduling and/or configuring an upstream transmission or reception.

In some examples, the WAB-NE 604 may send (e.g., via an XnAP IE), a configuration of allocated resources or H/S/NA resources to the NE 102. In WAB systems, the two base stations, such as the NE 102 and the WAB-NE 604, may be considered peer network nodes (e.g., without a strict top-down hierarchy). Therefore, a resource configuration from the WAB-NE 604 to the WAB node 602 may provide for the WAB-NE 604 to preempt the use of one or more resources to adapt to traffic and QoS uses. Additionally, or alternatively, the NE 102 may configure the WAB-MT 606 with L1 and/or L2 signaling, for example a UCI message or a MAC-CE message, which the WAB-MT 606 may use for indicating availability or usage of resources to the NE 102.

The different steps described for the example examples, in the text and in the flowcharts, may be permuted. Each configuration may be provided by one or more configurations in practice. An earlier configuration may provide a subset of parameters while a later configuration may provide another subset of parameters. Additionally, or alternatively, a later configuration may override values provided by an earlier configuration or a pre-configuration. A configuration may be provided by an Xn and/or NG signaling, a RRC signaling, a MAC signaling, a PHY layer signaling, such as a DCI message, or any combination thereof, among other examples. A configuration may include a pre-configuration, or a semi-static configuration, provided by a standard, by a vendor, and/or by a network and/or operator (e.g., an OAM). A parameter value received through configuration or indication may override previous values for a similar parameter.

L1 and/or L2 control signaling may refer to control signaling in layer 1 (e.g., PHY layer) or layer 2 (e.g., data link layer). Particularly, an L1 and/or L2 control signaling may refer to an L1 control signaling such as a DCI message or a UCI message, an L2 control signaling such as a MAC message, or any combination thereof. A format and an interpretation of an L1 and/or L2 control signaling may be determined by the standard, a configuration, other control signaling, or a combination thereof. Reference is frequently made, in the present disclosure, to a message or an information element (e.g., IE), which refers to a configuration at layer 3 and higher. An IE may be included in a message from one layer to another layer or from one entity to another entity. Additionally, or alternatively, an IE may include another IE. The terms ‘IE’ and ‘message’ may be used interchangeably when the message includes the IE directly or indirectly.

Any parameter may appear, in practice, as a linear function of that parameter in signaling or specifications. A beam indication may refer to an indication of a reference signal by an identifier (ID) or indicator, a resource associated with a reference signal, a spatial relation information including information of a reference signal or a reciprocal of a reference signal (e.g., in the case of beam correspondence). Despite frequent reference to specific types of reference signals, such as CSI-RS, SRS, SSB, or the like, systems and methods are not limited in scope to the specific reference signals. In some examples, other types of reference signals may be used, which may include reference signals specified for the purposes pursued in the present disclosure. The terms “parameter” and a “value” for the parameter may be used interchangeably. A parameter may be a sequence and/or array of parameters in various realizations.

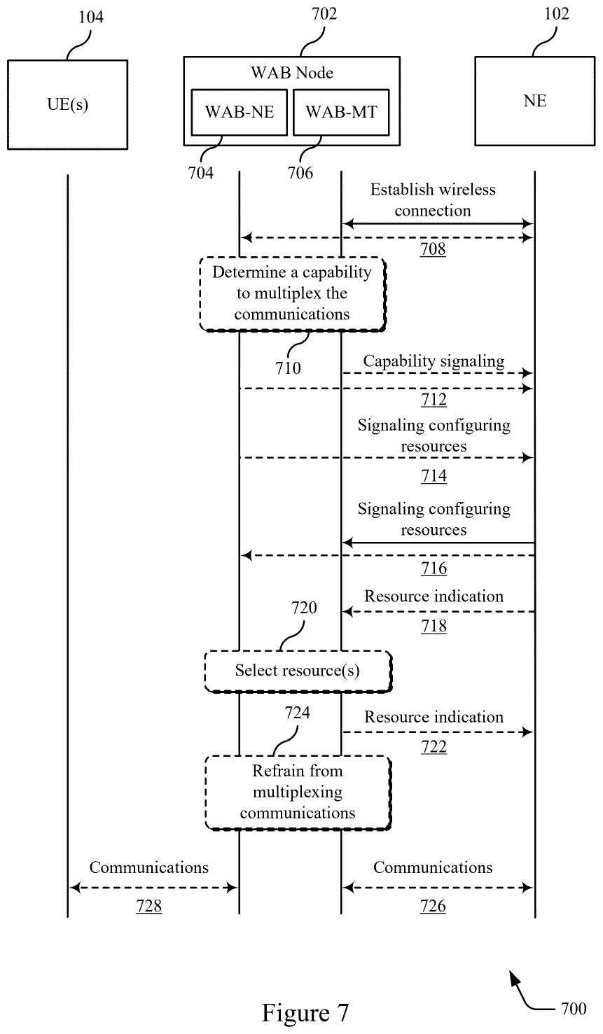

FIG. 7 illustrates an example of a signaling diagram 700 in accordance with aspects of the present disclosure. In some examples, the signaling diagram 700 may implement aspects of the wireless communications system 100, the WAB architecture diagram 200, the WAB architecture diagram 300, the protocol stack diagram 400, the protocol stack diagram 500, and/or the WAB architecture diagram 600. The signaling diagram 700 may illustrate an example of resource management for communications at a WAB node 702. The WAB node 702 can include one or more WAB-NEs 704 and/or one or more WAB-MTs 706, where the WAB node 702, the WAB-NEs 704, and the WAB-MTs 706 may be examples of the corresponding devices as described with reference to FIGS. 1 through 6. Alternative examples of the following may be implemented, where some processes are performed in a different order than described or are not performed. In some cases, processes may include additional features not mentioned below, or further processes may be added.

At 708, a WAB-MT 706 and a NE 102 can establish a wireless connection between the WAB node 702 (e.g., including the WAB-NE 704) and the NE 102. For example, the WAB-MT 706 and the NE 102 can establish a Uu connection through an RRC connection signaling, as described with reference to FIG. 2. The WAB-NE 704 and the NE 102 can include respective base stations and/or functionality of respective base stations. In some variations, the WAB-NE 704 and the NE 102 can establish a wireless connection (e.g., via a wireless backhaul interface) over the wireless connection between the WAB-MT 706 and the NE 102. For example, the wireless connection between the WAB-NE 704 and the NE 102 is established via an Xn interface over the Uu connection.

In some cases, at 710, the WAB node 702 can determine a capability of the WAB node 702 to multiplex the communications. The capability can include a capability of the WAB node 702 to implement TDM techniques, FDM techniques, and/or full duplex communications. The capability may be determined by an implementation of the WAB node 702, a pre-configuration at the WAB node 702 or the WAB-NE 704 or the WAB-MT 706, a self-interference between the WAB-NE 704 and WAB-MT 706, beams applied by the WAB-NE 704 and WAB-MT 706, or any combination thereof.

In some examples, at 712, the WAB node 702 can transmit signaling that indicates the capability of the WAB node 702 to multiplex the communications to the NE 102. In one example, the WAB-MT 706 can transmit the signaling that indicates the capability to the WAB node 702 via the wireless connection established at 708. In this example, the capability signaling may include an RRC signaling or an L1/L2 signaling on the Uu connection (e.g., link). In another example, the WAB-NE 704 may send the capability signaling to the NE 102. In this example, the capability signaling may include an XnAP signaling over the Xn interface established over the Uu link.

In some variations, at 714, the WAB node 702 can transmit signaling configuring one or more resources to the NE 102 (e.g., the WAB-NE 706 via the wireless connection established by the WAB-MT 706). For example, the signaling can include an indication that the resources are at least one of uplink resources, downlink resources, or flexible resources. In some cases, the WAB node 702 can select at least one resource to use for communications and can indicate the resource to the NE 102 in the signaling at 714, where the signaling can include RRC signaling with an IE that indicates the resource.

At 716, the WAB node 702 (e.g., the WAB-MT 706 and/or the WAB-NE 704 via the Xn interface established over the Uu link) receives signaling via the wireless connection that configures one or more resources for communications between the WAB node 702 and one or more devices. The one or more devices can include the NE 102 and/or the UEs 104. The resources can include the same resources, different resources, or a portion of the resources indicated by the WAB node 702 at 714.

In some examples, the signaling includes an indication that one or more resources of the resources are available for the communications, unavailable for the communications, or are to be configured as available or unavailable by additional signaling (e.g., a DCI message, a MAC-CE, or other signaling). In some variations, the resources can be configured as available depending on one or more of a channel sent using the resources or a signal sent using the resources. Additionally, or alternatively, the signaling includes an indication that the resources are at least one of uplink resources, downlink resources, or flexible resources.

In some cases, the signaling indicates one or more of a periodicity of the resources or waveform parameters for the communications. Additionally, or alternatively, the signaling can indicate that the resources are to be used for the communications between the WAB-MT 706 of the WAB node 702 and the NE 102. In some cases, the signaling includes RRC signaling.

In some cases, at 718, the WAB node 702 can receive signaling that indicates at least one resource of the resources configured at 716 to use for the communications and that indicates a communication direction (e.g., uplink or downlink) for the respective resources of the one or more resources. The signaling can include a DCI message or a MAC-CE, among other examples.

In some examples, at 720, the WAB node 702 can select one or more resources to use for communications. The one or more resources can be the same resources as indicated by the signaling configuring the resources at 714, the signaling configuring the resources at 716, and/or the resource indication at 718. For example, the WAB node 702 can select one or more resources by evaluating one or more of a channel to be sent using the resources or the signal to be sent using the communications, where resources can be configured as available for defined channels and/or signals.

In some variations, at 722, the WAB node 702 can transmit an indication of the selected

resources. For example, the WAB-MT 706 can transmit third signaling that indicates the one or more resources selected at 720 to the NE 102. The signaling configuring the resources at 716 can include a first IE in RRC signaling, and the indication of the selected resources can include a second

IE in RRC signaling.

In some cases, at 724, the WAB node 702 can refrain from multiplexing (e.g., not multiplex, cancel transmission and/or reception of communications) communications between the WAB-NE 704 and the UEs 104 with communications between the WAB-MT 706 and the NE 102 on a resource (e.g., a resource indicated by the resource indication at 722, the resource indication at 718, and/or the signaling that configures the resources at 716). For example, the WAB node 702 can refrain from multiplexing the communications if the WAB node 702 is not capable of full duplex communications, not capable of MT-transmission and NE-transmission, not capable of MT-reception and NE-reception, not capable of MT-reception and NE-transmission, not capable of MT-transmission and NE-reception, and/or if FDM techniques are implemented. Additionally, or alternatively, the WAB node 702 can multiplex the communications if the WAB node 702 is capable of full duplex communications, capable of MT-transmission and NE-transmission, capable of MT-reception and NE-reception, capable of MT-reception and NE-transmission, capable of MT-transmission and NE-reception, and/or if FDM techniques are not implemented.

In some examples, the WAB node 702 can receive signaling from the NE 102 that indicates whether the WAB node 702 is to refrain from multiplexing the communications (e.g., via the wireless connection established by the WAB-MT 706).

At 726 and/or at 728, the WAB node 702 can perform the communications between the WAB node 702 and the one or more devices using at least a portion of the resources. For example, at 726, the WAB-MT 706 can transmit and/or receive signaling to and from the NE 102, respectively. Additionally, or alternatively, at 728, the WAB-NE 704 can transmit and/or receive signaling to and from the UEs 104, respectively.

In some examples, the WAB node 702 can transmit signaling that indicates at least one of a channel included in the communications or a signal included in the communications to the NE 102 (e.g., via the wireless connection established at 708). The communications can be between the WAB-NE 704 and the UEs 104.

In some cases, the resources can include at least one of a symbol, a slot, an RB set, and/or an RB set group.

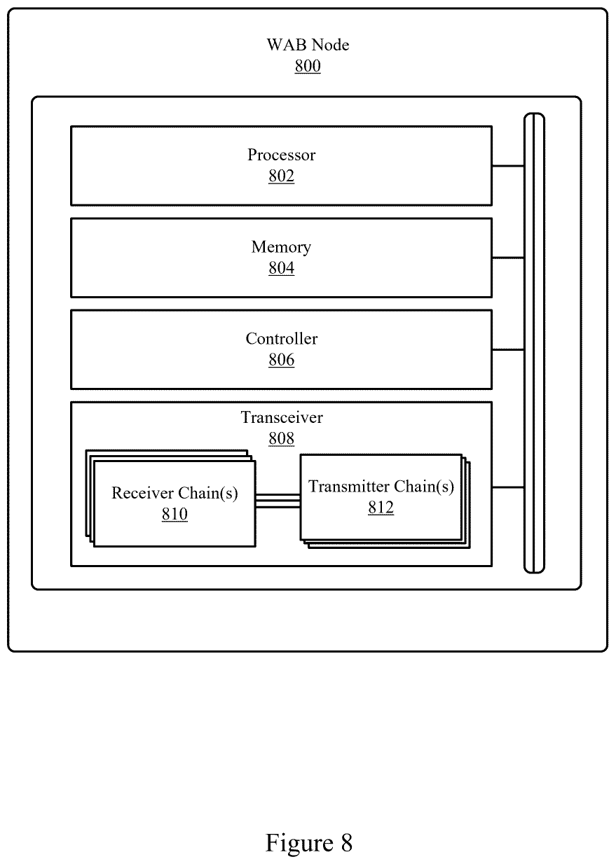

FIG. 8 illustrates an example of a WAB node 800 in accordance with aspects of the present disclosure. The WAB node 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces. The WAB node 800 can implement aspects of a UE (e.g., a WAB-MT) and a NE (e.g., a WAB-NE), as described with reference to FIGS. 1 through 7.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the WAB node 800 to perform various functions of the present disclosure.

The memory 804 may include volatile or non-volatile memory. The memory 804 may store computer-readable, computer-executable code including instructions when executed by the processor 802 cause the WAB node 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the WAB node 800 to perform one or more of the functions described herein (e.g., executing, by the processor 802, instructions stored in the memory 804). For example, the processor 802 may support wireless communication at the WAB node 800 in accordance with examples as disclosed herein. The WAB node 800 may be configured to or operable to support a means for establishing, via a first component of the node, a wireless connection between a second component of the node and a first base station, the second component of the node including a second base station, receiving, from the first base station and via the wireless connection, first signaling configuring resources associated with communications between the node and one or more devices, and performing the communications between the node and the one or more devices based on the resources.

Additionally, the WAB node 800 may be configured to support any one or combination of to receive the first signaling, transmitting, to the first base station and via the wireless connection, second signaling configuring the resources. Additionally, or alternatively, the second signaling includes an indication that the resources include at least one of uplink resources, downlink resources, or flexible resources, and the first signaling includes an indication that one or more resources of the resources are available for the communications, unavailable for the communications, or are to be configured as available or unavailable by third signaling. Additionally, or alternatively, the WAB node 800 may be configured to support selecting at least one resource from the resources for performing the communications, where the second signaling includes an indication of the at least one resource, and the second signaling includes an IE associated with RRC signaling. Additionally, or alternatively, the first signaling includes an indication that the resources include at least one of uplink resources, downlink resources, or flexible resources. Additionally, or alternatively, the first signaling includes an indication that one or more resources of the resources are available for the communications, unavailable for the communications, or are to be configured as available or unavailable by second signaling.

Additionally, or alternatively, the indication that the one or more resources of the resources are available for the communications is based on one or more of a channel associated with the resources or a signal associated with the resources, and where the WAB node 800 may be configured to support selecting at least one resource from the resources for performing the communications based on one or more of the channel associated with the communications or the signal associated with the communications. Additionally, or alternatively, the WAB node 800 may be configured to support transmitting, to the first base station and via the wireless connection, third signaling that indicates the one or more resources. Additionally, or alternatively, the first signaling indicates one or more of a periodicity associated with the resources or waveform parameters associated with the communications, the first signaling indicates that the resources are to be used for the communications between the first component of the node and the one or more devices, the first signaling includes RRC signaling, and the one or more devices include at least the second base station. Additionally, or alternatively, the WAB node 800 may be configured to support receiving, from the first base station via the wireless connection, second signaling that indicates at least one resource of the resources to use for the communications and that indicates a communication direction associated with the at least one resource, and where the communication direction includes at least one of an uplink communication direction or a downlink communication direction, and the second signaling includes a DCI message or a MAC-CE.

Additionally, or alternatively, the WAB node 800 may be configured to support refraining from multiplexing other communications between the second component of the node and the one or more devices with the communications between the first component of the node and the one or more devices on the at least one resource. Additionally, or alternatively, to refrain from multiplexing the other communications between the second component of the node and the one or more devices with the communications between the first component of the node and the one or more devices on the at least one resource, the WAB node 800 may be configured to support determining a capability of the node to multiplex the other communications between the second component of the node and the one or more devices with the communications between the first component of the node and the one or more devices on the at least one resource, and transmitting, to the first base station via the wireless connection, third signaling that indicates the capability of the node to multiplex the other communications between the second component of the node and the one or more devices with the communications between the first component of the node and the one or more devices on the at least one resource, where the first signaling is received in response to transmitting the third signaling, and the capability is associated with at least one of TDM, FDM, or full duplex communications.

Additionally, or alternatively, to refrain from multiplexing the other communications between the second component of the node and the one or more devices with the communications between the first component of the node and the one or more devices on the at least one resource, the WAB node 800 may be configured to support receiving, from the first base station and via the wireless connection, third signaling that indicates for the node to refrain from multiplexing the other communications between the second component of the node and the one or more devices with the communications between the first component of the node and the one or more devices on the at least one resource. Additionally, or alternatively, the WAB node 800 may be configured to support selecting, based on the first signaling configuring the resources, at least one resource from the resources to use for transmitting or receiving the communications, and transmitting, to the first base station and via the wireless connection, second signaling that indicates the at least one resource, where the first signaling includes a first IE and the second signaling includes a second IE. Additionally, or alternatively, the WAB node 800 may be configured to support transmitting, to the first base station and via the wireless connection, second signaling that indicates at least one of a channel associated with the communications or a signal associated with the communications, and where the communications are between the second component of the node and the one or more devices, and the one or more devices include at least one UE. Additionally, or alternatively, the resources include at least one of a symbol, a slot, an RB set, an RB set group.

Additionally, or alternatively, the WAB node 800 may support at least one memory (e.g., the memory 804) and at least one processor (e.g., the processor 802) coupled with the at least one memory and configured to cause the WAB node 800 to establish, via a first component of the node, a wireless connection between a second component of the node and a first base station, the second component of the node including a second base station, receive, from the first base station and via the wireless connection, first signaling configuring resources associated with communications between the node and one or more devices, and perform the communications between the node and the one or more devices based on the resources.

Additionally, the WAB node 800 may be configured to support any one or combination of to receive the first signaling, the at least one processor is configured to cause the WAB node to transmit, to the first base station and via the wireless connection, second signaling configuring the resources. Additionally, or alternatively, the second signaling includes an indication that the resources include at least one of uplink resources, downlink resources, or flexible resources, and the first signaling includes an indication that one or more resources of the resources are available for the communications, unavailable for the communications, or are to be configured as available or unavailable by third signaling. Additionally, or alternatively, the at least one processor is configured to cause the WAB node to select at least one resource from the resources for performing the communications, where the second signaling includes an indication of the at least one resource, and the second signaling includes an IE associated with RRC signaling. Additionally, or alternatively, the first signaling includes an indication that the resources include at least one of uplink resources, downlink resources, or flexible resources. Additionally, or alternatively, the first signaling includes an indication that one or more resources of the resources are available for the communications, unavailable for the communications, or are to be configured as available or unavailable by second signaling.

Additionally, or alternatively, the indication that the one or more resources of the resources are available for the communications is based on one or more of a channel associated with the resources or a signal associated with the resources, where the at least one processor is configured to cause the WAB node to select at least one resource from the resources for performing the communications based on one or more of the channel associated with the communications or the signal associated with the communications. Additionally, or alternatively, the at least one processor is configured to cause the WAB node to transmit, to the first base station and via the wireless connection, third signaling that indicates the one or more resources. Additionally, or alternatively, the first signaling indicates one or more of a periodicity associated with the resources or waveform parameters associated with the communications, the first signaling indicates that the resources are to be used for the communications between the first component of the node and the one or more devices, the first signaling includes RRC signaling, and the one or more devices include at least the second base station. Additionally, or alternatively, the at least one processor is configured to cause the WAB node to receive, from the first base station via the wireless connection, second signaling that indicates at least one resource of the resources to use for the communications and that indicates a communication direction associated with the at least one resource, and where the communication direction includes at least one of an uplink communication direction or a downlink communication direction, and the second signaling includes a DCI message or a MAC-CE.

Additionally, or alternatively, the at least one processor is configured to cause the WAB node to refrain from multiplexing other communications between the second component of the node and the one or more devices with the communications between the first component of the node and the one or more devices on the at least one resource. Additionally, or alternatively, to refrain from multiplexing the other communications between the second component of the node and the one or more devices with the communications between the first component of the node and the one or more devices on the at least one resource, the at least one processor is configured to cause the WAB node to determine a capability of the node to multiplex the other communications between the second component of the node and the one or more devices with the communications between the first component of the node and the one or more devices on the at least one resource, and transmit, to the first base station via the wireless connection, third signaling that indicates the capability of the node to multiplex the other communications between the second component of the node and the one or more devices with the communications between the first component of the node and the one or more devices on the at least one resource, where the first signaling is received in response to transmitting the third signaling, and the capability is associated with at least one of TDM, FDM, or full duplex communications.

Additionally, or alternatively, to refrain from multiplexing the other communications between the second component of the node and the one or more devices with the communications between the first component of the node and the one or more devices on the at least one resource, the at least one processor is configured to cause the WAB node to receive, from the first base station and via the wireless connection, third signaling that indicates for the node to refrain from multiplexing the other communications between the second component of the node and the one or more devices with the communications between the first component of the node and the one or more devices on the at least one resource. Additionally, or alternatively, the at least one processor is configured to cause the WAB node to select, based on the first signaling configuring the resources, at least one resource from the resources to use for transmitting or receiving the communications, and transmit, to the first base station and via the wireless connection, second signaling that indicates the at least one resource, where the first signaling includes a first IE and the second signaling includes a second IE. Additionally, or alternatively, the at least one processor is configured to cause the WAB node to transmit, to the first base station and via the wireless connection, second signaling that indicates at least one of a channel associated with the communications or a signal associated with the communications, where the communications are between the second component of the node and the one or more devices, and the one or more devices include at least one UE. Additionally, or alternatively, the resources include at least one of a symbol, a slot, an RB set, an RB set group.

The controller 806 may manage input and output signals for the WAB node 800. The controller 806 may also manage peripherals not integrated into the WAB node 800. In some implementations, the controller 806 may utilize an operating system such as iOS®, ANDROID®, WINDOWS®, or other operating systems. In some implementations, the controller 806 may be implemented as part of the processor 802.

In some implementations, the WAB node 800 may include at least one transceiver 808. In some other implementations, the WAB node 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

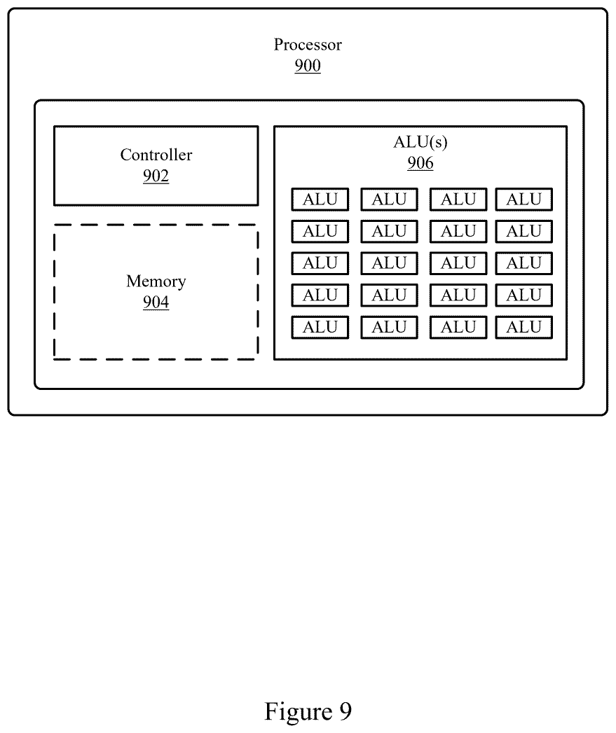

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to establish, via a first component of the node, a wireless connection between a second component of the node and a first base station, the second component of the node including a second base station, receive, from the first base station and via the wireless connection, first signaling configuring resources associated with communications between the node and one or more devices, and perform the communications between the node and the one or more devices based on the resources.

Additionally, the processor 900 may be configured to or operable to support any one or combination of to receive the first signaling, the at least one controller is configured to cause the processor to transmit, to the first base station and via the wireless connection, second signaling configuring the resources. Additionally, or alternatively, the second signaling includes an indication that the resources include at least one of uplink resources, downlink resources, or flexible resources, and the first signaling includes an indication that one or more resources of the resources are available for the communications, unavailable for the communications, or are to be configured as available or unavailable by third signaling. Additionally, or alternatively, the at least one controller is configured to cause the processor to select at least one resource from the resources for performing the communications, where the second signaling includes an indication of the at least one resource, and the second signaling includes an IE associated with RRC signaling. Additionally, or alternatively, the first signaling includes an indication that the resources include at least one of uplink resources, downlink resources, or flexible resources. Additionally, or alternatively, the first signaling includes an indication that one or more resources of the resources are available for the communications, unavailable for the communications, or are to be configured as available or unavailable by second signaling.

Additionally, or alternatively, the indication that the one or more resources of the resources are available for the communications is based on one or more of a channel associated with the resources or a signal associated with the resources, where the at least one controller is configured to cause the processor to select at least one resource from the resources for performing the communications based on one or more of the channel associated with the communications or the signal associated with the communications. Additionally, or alternatively, the at least one controller is configured to cause the processor to transmit, to the first base station and via the wireless connection, third signaling that indicates the one or more resources. Additionally, or alternatively, the first signaling indicates one or more of a periodicity associated with the resources or waveform parameters associated with the communications, the first signaling indicates that the resources are to be used for the communications between the first component of the processor and the one or more devices, the first signaling includes RRC signaling, and the one or more devices include at least the second base station. Additionally, or alternatively, the at least one controller is configured to cause the processor to receive, from the first base station via the wireless connection, second signaling that indicates at least one resource of the resources to use for the communications and that indicates a communication direction associated with the at least one resource, and where the communication direction includes at least one of an uplink communication direction or a downlink communication direction, and the second signaling includes a DCI message or a MAC-CE.

Additionally, or alternatively, the at least one controller is configured to cause the processor to refrain from multiplexing other communications between the second component of the processor and the one or more devices with the communications between the first component of the processor and the one or more devices on the at least one resource. Additionally, or alternatively, to refrain from multiplexing the other communications between the second component of the processor and the one or more devices with the communications between the first component of the processor and the one or more devices on the at least one resource, the at least one controller is configured to cause the processor to determine a capability of the processor to multiplex the other communications between the second component of the processor and the one or more devices with the communications between the first component of the processor and the one or more devices on the at least one resource, and transmit, to the first base station via the wireless connection, third signaling that indicates the capability of the processor to multiplex the other communications between the second component of the processor and the one or more devices with the communications between the first component of the processor and the one or more devices on the at least one resource, where the first signaling is received in response to transmitting the third signaling, and the capability is associated with at least one of TDM, FDM, or full duplex communications.

Additionally, or alternatively, to refrain from multiplexing the other communications between the second component of the processor and the one or more devices with the communications between the first component of the processor and the one or more devices on the at least one resource, the at least one controller is configured to cause the processor to receive, from the first base station and via the wireless connection, third signaling that indicates for the processor to refrain from multiplexing the other communications between the second component of the processor and the one or more devices with the communications between the first component of the processor and the one or more devices on the at least one resource. Additionally, or alternatively, the at least one controller is configured to cause the processor to select, based on the first signaling configuring the resources, at least one resource from the resources to use for transmitting or receiving the communications, and transmit, to the first base station and via the wireless connection, second signaling that indicates the at least one resource, where the first signaling includes a first IE and the second signaling includes a second IE. Additionally, or alternatively, the at least one controller is configured to cause the processor to transmit, to the first base station and via the wireless connection, second signaling that indicates at least one of a channel associated with the communications or a signal associated with the communications, where the communications are between the second component of the processor and the one or more devices, and the one or more devices include at least one UE. Additionally, or alternatively, the resources include at least one of a symbol, a slot, an RB set, an RB set group.

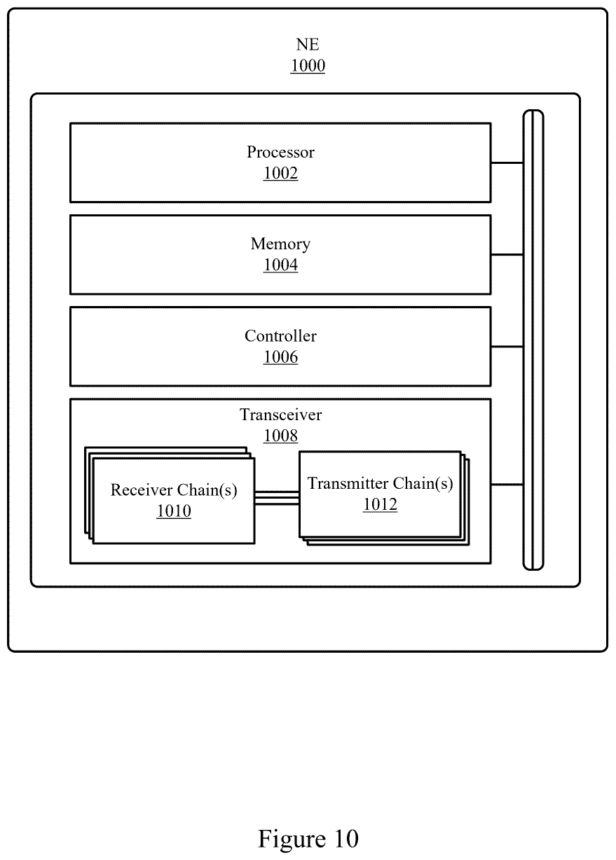

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to or operable to support a means for establishing a wireless connection between the NE and a first component of a node, the node including the first component and a second component including a base station, and transmitting, to the node and via the wireless connection, first signaling configuring resources associated with communications between the node and one or more devices.

Additionally, the NE 1000 may be configured to or operable to support any one or combination of the method further comprising receiving, from the node and via the wireless connection, second signaling configuring the resources. Additionally, or alternatively, the second signaling includes an indication that the resources include at least one of uplink resources, downlink resources, or flexible resources, and the first signaling includes an indication that one or more resources of the resources are available for the communications, unavailable for the communications, or are to be configured as available or unavailable by third signaling. Additionally, or alternatively, the second signaling includes an indication of at least one resource of the resources, and the second signaling includes an IE associated with RRC signaling. Additionally, or alternatively, the first signaling includes an indication that the resources include at least one of uplink resources, downlink resources, or flexible resources. Additionally, or alternatively, the first signaling includes an indication that one or more resources of the resources are available for the communications, unavailable for the communications, or are to be configured as available or unavailable by second signaling. Additionally, or alternatively, the indication that the one or more resources of the resources are available for the communications is based on one or more of a channel associated with the resources or a signal associated with the resources. Additionally, or alternatively, the method further comprising receiving, from the node and via the wireless connection, third signaling that indicates the one or more resources.

Additionally, or alternatively, the first signaling indicates one or more of a periodicity associated with the resources or waveform parameters associated with the communications, the first signaling indicates that the resources are to be used for the communications between the first component of the node and the one or more devices, the first signaling includes RRC signaling, and the one or more devices include at least the NE. Additionally, or alternatively, the method further comprising transmitting, to the node via the wireless connection, second signaling that indicates at least one resource of the resources to use for the communications and that indicates a communication direction associated with the at least one resource, and where the communication direction includes at least one of an uplink communication direction or a downlink communication direction, and the second signaling includes a DCI message or a MAC-CE. Additionally, or alternatively, the method further comprising receiving, from the node via the wireless connection, third signaling that indicates a capability of the node to multiplex other communications between the second component of the node and the one or more devices with the communications between the first component of the node and the one or more devices on the at least one resource, where the first signaling is transmitted in response to receiving the third signaling, and the capability is associated with at least one of TDM, FDM, or full duplex communications.

Additionally, or alternatively, the method further comprising transmitting, to the node and via the wireless connection, third signaling that indicates for the node to refrain from multiplexing other communications between the second component of the node and the one or more devices with the communications between the first component of the node and the one or more devices on the at least one resource. Additionally, or alternatively, the method further comprising receiving, from the node and via the wireless connection, second signaling that indicates at least one resource used for transmitting or receiving the communications, and where the first signaling includes a first IE and the second signaling includes a second IE. Additionally, or alternatively, the method further comprising receiving, from the node and via the wireless connection, second signaling that indicates at least one of a channel associated with the communications or a signal associated with the communications, and where the communications are between the second component of the node and the one or more devices, and the one or more devices include at least one UE. Additionally, or alternatively, the resources include at least one of a symbol, a slot, an RB set, an RB set group.

Additionally, or alternatively, the NE 1000 may support at least one memory (e.g., the memory 1004) and at least one processor (e.g., the processor 1002) coupled with the at least one memory and configured to cause the NE to establish a wireless connection between the NE and a first component of a node, the node including the first component and a second component including a base station, and transmit, to the node and via the wireless connection, first signaling configuring resources associated with communications between the node and one or more devices.

Additionally, the NE 1000 may be configured to support any one or combination of the at least one processor is configured to cause the NE to receive, from the node and via the wireless connection, second signaling configuring the resources. Additionally, or alternatively, the second signaling includes an indication that the resources include at least one of uplink resources, downlink resources, or flexible resources, and the first signaling includes an indication that one or more resources of the resources are available for the communications, unavailable for the communications, or are to be configured as available or unavailable by third signaling. Additionally, or alternatively, the second signaling includes an indication of at least one resource of the resources, and the second signaling includes an IE associated with RRC signaling. Additionally, or alternatively, the first signaling includes an indication that the resources include at least one of uplink resources, downlink resources, or flexible resources. Additionally, or alternatively, the first signaling includes an indication that one or more resources of the resources are available for the communications, unavailable for the communications, or are to be configured as available or unavailable by second signaling. Additionally, or alternatively, the indication that the one or more resources of the resources are available for the communications is based on one or more of a channel associated with the resources or a signal associated with the resources. Additionally, or alternatively, the NE receives, from the node and via the wireless connection, third signaling that indicates the one or more resources.

Additionally, or alternatively, the first signaling indicates one or more of a periodicity associated with the resources or waveform parameters associated with the communications, the first signaling indicates that the resources are to be used for the communications between the first component of the node and the one or more devices, the first signaling includes RRC signaling, and the one or more devices include at least the NE. Additionally, or alternatively, the at least one processor is configured to cause the NE to transmit, to the node via the wireless connection, second signaling that indicates at least one resource of the resources to use for the communications and that indicates a communication direction associated with the at least one resource, and where the communication direction includes at least one of an uplink communication direction or a downlink communication direction, and the second signaling includes a DCI message or a MAC-CE. Additionally, or alternatively, the at least one processor is configured to cause the NE to receive, from the node via the wireless connection, third signaling that indicates a capability of the node to multiplex other communications between the second component of the node and the one or more devices with the communications between the first component of the node and the one or more devices on the at least one resource, where the first signaling is transmitted in response to receiving the third signaling, and the capability is associated with at least one of TDM, FDM, or full duplex communications.

Additionally, or alternatively, the at least one processor is configured to cause the NE to transmit, to the node and via the wireless connection, third signaling that indicates for the node to refrain from multiplexing other communications between the second component of the node and the one or more devices with the communications between the first component of the node and the one or more devices on the at least one resource. Additionally, or alternatively, the at least one processor is configured to cause the NE to receive, from the node and via the wireless connection, second signaling that indicates at least one resource used for transmitting or receiving the communications, and where the first signaling includes a first IE and the second signaling includes a second IE. Additionally, or alternatively, the at least one processor is configured to cause the NE to receive, from the node and via the wireless connection, second signaling that indicates at least one of a channel associated with the communications or a signal associated with the communications, and where the communications are between the second component of the node and the one or more devices, and the one or more devices include at least one UE. Additionally, or alternatively, the resources include at least one of a symbol, a slot, an RB set, an RB set group.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

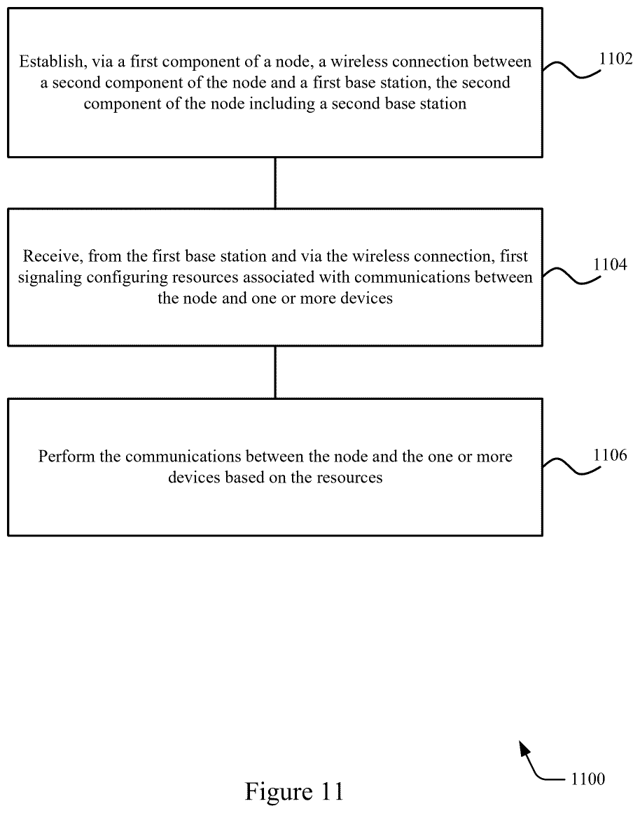

FIG. 11 illustrates a flowchart of a method 1100 in accordance with aspects of the present disclosure. The operations of the method may be implemented by a node (e.g., a WAB node) as described herein. In some implementations, the node may execute a set of instructions to control the function elements of the node to perform the described functions. It should be noted that the method described herein describes a possible implementation, and that the operations and the steps may be rearranged or otherwise modified and that other implementations are possible.

At 1102, the method may include establishing, via a first component of a node, a wireless connection between a second component of the node and a first base station, the second component of the node including a second base station. The operations of 1102 may be performed in accordance with examples as described herein. In some implementations, aspects of the operations of 1102 may be performed by a WAB node as described with reference to FIG. 8.

At 1104, the method may include receiving, from the first base station and via the wireless connection, first signaling configuring resources associated with communications between the node and one or more devices. The operations of 1104 may be performed in accordance with examples as described herein. In some implementations, aspects of the operations of 1104 may be performed by a WAB node as described with reference to FIG. 8.

At 1106, the method may include performing the communications between the node and the one or more devices based on the resources. The operations of 1106 may be performed in accordance with examples as described herein. In some implementations, aspects of the operations of 1106 may be performed a WAB node as described with reference to FIG. 8.

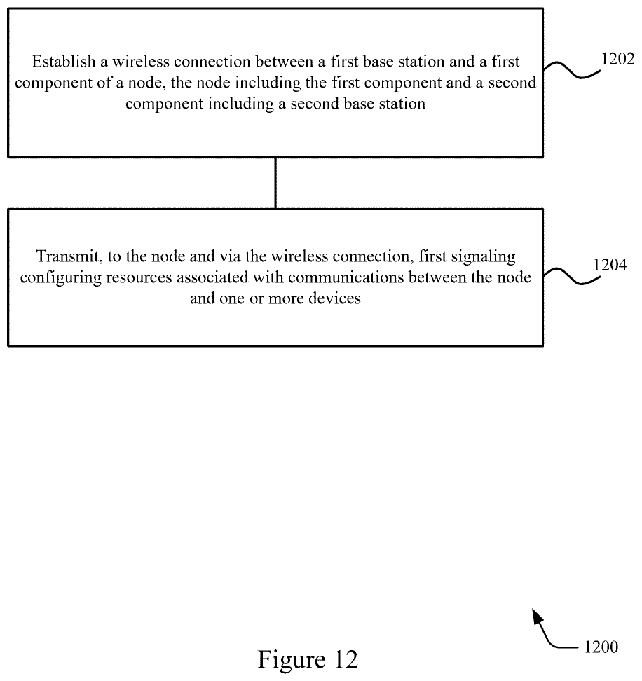

FIG. 12 illustrates a flowchart of a method 1200 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include establishing a wireless connection between a first base station and a first component of a node, the node including the first component and a second component including a second base station. The operations of 1202 may be performed in accordance with examples as described herein. In some implementations, aspects of the operations of 1202 may be performed by a NE as described with reference to FIG. 10.

At 1204, the method may include transmitting, to the node and via the wireless connection, first signaling configuring resources associated with communications between the node and one or more devices. The operations of 1204 may be performed in accordance with examples as described herein. In some implementations, aspects of the operations of 1204 may be performed by a NE as described with reference to FIG. 10.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A node for wireless communication, comprising:
at least one memory; and
at least one processor coupled with the at least one memory and configured to cause the node to:
establish, via a first component of the node, a wireless connection between a second component of the node and a first base station, the second component of the node comprising a second base station;
receive, from the first base station and via the wireless connection, first signaling configuring resources associated with communications between the node and one or more devices; and
perform the communications between the node and the one or more devices based at least in part on the resources.

2. The node of claim 1, wherein to receive the first signaling, the at least one processor is configured to cause the node to transmit, to the first base station and via the wireless connection, second signaling configuring the resources.

3. The node of claim 2, wherein:
the second signaling comprises an indication that the resources comprise at least one of uplink resources, downlink resources, or flexible resources; and
the first signaling comprises an indication that one or more resources of the resources are available for the communications, unavailable for the communications, or are to be configured as available or unavailable by third signaling.

4. The node of claim 2, wherein the at least one processor is configured to cause the node to select at least one resource from the resources for performing the communications, and wherein:
the second signaling comprises an indication of the at least one resource; and
the second signaling comprises an information element (IE) associated with radio resource control (RRC) signaling.

5. The node of claim 1, wherein the first signaling comprises an indication that the resources comprise at least one of uplink resources, downlink resources, or flexible resources.

6. The node of claim 1, wherein the first signaling comprises an indication that one or more resources of the resources are available for the communications, unavailable for the communications, or are to be configured as available or unavailable by second signaling.

7. The node of claim 6, wherein the indication that the one or more resources of the resources are available for the communications is based at least in part on one or more of a channel associated with the resources or a signal associated with the resources, and wherein the at least one processor is configured to cause the node to select at least one resource from the resources for performing the communications based at least in part on one or more of the channel associated with the communications or the signal associated with the communications.

8. The node of claim 6, wherein the at least one processor is configured to cause the node to transmit, to the first base station and via the wireless connection, third signaling that indicates the one or more resources.

9. The node of claim 1, wherein:
the first signaling indicates one or more of a periodicity associated with the resources or waveform parameters associated with the communications;
the first signaling indicates that the resources are to be used for the communications between the first component of the node and the one or more devices;
the first signaling comprises radio resource control (RRC) signaling; and
the one or more devices comprise at least the second base station.

10. The node of claim 1, wherein the at least one processor is configured to cause the node to receive, from the first base station via the wireless connection, second signaling that indicates at least one resource of the resources to use for the communications and that indicates a communication direction associated with the at least one resource, and wherein:
the communication direction comprises at least one of an uplink communication direction or a downlink communication direction; and
the second signaling comprises a downlink control information (DCI) message or a medium access control-control element (MAC-CE).

11. The node of claim 10, wherein the at least one processor is configured to cause the node to refrain from multiplexing other communications between the second component of the node and the one or more devices with the communications between the first component of the node and the one or more devices on the at least one resource.

12. The node of claim 11, wherein to refrain from multiplexing the other communications between the second component of the node and the one or more devices with the communications between the first component of the node and the one or more devices on the at least one resource, the at least one processor is configured to cause the node to:
determine a capability of the node to multiplex the other communications between the second component of the node and the one or more devices with the communications between the first component of the node and the one or more devices on the at least one resource; and
transmit, to the first base station via the wireless connection, third signaling that indicates the capability of the node to multiplex the other communications between the second component of the node and the one or more devices with the communications between the first component of the node and the one or more devices on the at least one resource, wherein:
the first signaling is received in response to transmitting the third signaling; and
the capability is associated with at least one of time division multiplexing (TDM), frequency division multiplexing (FDM), or full duplex communications.

13. The node of claim 11, wherein to refrain from multiplexing the other communications between the second component of the node and the one or more devices with the communications between the first component of the node and the one or more devices on the at least one resource, the at least one processor is configured to cause the node to receive, from the first base station and via the wireless connection, third signaling that indicates for the node to refrain from multiplexing the other communications between the second component of the node and the one or more devices with the communications between the first component of the node and the one or more devices on the at least one resource.

14. The node of claim 1, wherein the at least one processor is further configured to cause the node to:
select, based on the first signaling configuring the resources, at least one resource from the resources to use for transmitting or receiving the communications; and
transmit, to the first base station and via the wireless connection, second signaling that indicates the at least one resource, wherein the first signaling comprises a first information element (IE) and the second signaling comprises a second IE.

15. The node of claim 1, wherein the at least one processor is further configured to cause the node to transmit, to the first base station and via the wireless connection, second signaling that indicates at least one of a channel associated with the communications or a signal associated with the communications, and wherein:
the communications are between the second component of the node and the one or more devices; and
the one or more devices comprise at least one user equipment (UE).

16. The node of claim 1, wherein the resources comprise at least one of a symbol, a slot, a resource block set, a resource block set group.

17. A processor for wireless communication, comprising:
at least one controller coupled with at least one memory and configured to cause the processor to:
establish, via a first component of the processor, a wireless connection between a second component of the processor and a first base station, the second component of the processor associated with a second base station;
receive, from the first base station and via the wireless connection, first signaling configuring resources associated with communications between the processor and one or more devices; and
perform the communications between the processor and the one or more devices based at least in part on the resources.

18. A method performed by a node, the method comprising:
establishing, via a first component of the node, a wireless connection between a second component of the node and a first base station, the second component of the node comprising a second base station;
receiving, from the first base station and via the wireless connection, first signaling configuring resources associated with communications between the node and one or more devices; and
performing the communications between the node and the one or more devices based at least in part on the resources.

19. A first base station for wireless communication, comprising:
at least one memory; and
at least one processor coupled with the at least one memory and configured to cause the first base station to:
establish a wireless connection between the first base station and a first component of a node, the node comprising the first component and a second component comprising a second base station; and
transmit, to the node and via the wireless connection, first signaling configuring resources associated with communications between the node and one or more devices.

20. The first base station of claim 19, wherein to transmit the first signaling, the at least one processor is configured to cause the first base station to receive, from the node and via the wireless connection, second signaling configuring the resources.
